(19) United States
(12) Patent Application Publication
(10) Pub. No.: US 2015/0345708 A1
(43) Pub. Date: Dec. 3, 2015

(54) VORTEX FILL

(71) Applicant: AGILITY FUEL SYSTEMS, INC., Fontana, CA (US)

(72) Inventors: Todd F. SLOAN, Kelowna (CA); Chris FORSBERG, Kelowna (CA); Christopher E. CANNON, Alexandria, AL (US); Dursun MOORE, Los Angeles, CA (US); Sean STEVENS, Upland, CA (US)

(21) Appl. No.: 14/754,930

(22) Filed: Jun. 30, 2015

Related U.S. Application Data
(63) Continuation-in-part of application No. 14/150,126, filed on Jan. 8, 2014.
(60) Provisional application No. 62/018,716, filed on Jun. 30, 2014.
(60) Provisional application No. 61/750,229, filed on Jan. 8, 2013.

(51) Int. Cl. F17C 13/00; F17C 5/06; F17C 1/00

(52) U.S. Cl. CPC F17C 13/002; F17C 1/00; F17C 5/06; F17C 2201/056; F17C 2201/0104; F17C 2205/0391; F17C 2221/033; F17C 2223/0123; F17C 2223/035; F17C 2227/0339; F17C 2227/0388; F17C 2260/023; F17C 2265/065; F17C 2270/0168

(57) ABSTRACT

Improved methods, systems, and devices for filling fuel tanks, particularly compressed natural gas (CNG) fuel tanks, are provided. Such methods, systems, and devices enhance heat rejection when the fuel tank is being filled to a temperature lower than that if such methods, systems, and devices were not used. Pressure sensor logic on a fuel station will be less prone to error in gauging the mass of the fuel in the tank, enabling the tank to be filled more accurately and fully. To enhance heat rejection, the fuel tank may be provided with a heat sink to passively facilitate heat transfer from the fuel tank interior to the exterior. Alternatively or in combination, the fuel tank can be provided with a fuel flow channel through which fuel from the fuel tank interior is circulated. The fuel flow channel can be actively cooled with a fan or water cooling system.

### CROSS-REFERENCE

This application claims the benefit of U.S. Provisional Application No. 62/018,716, filed Jun. 30, 2014, and this application is also a continuation-in-part application of U.S. patent application Ser. No. 14/150,126, filed Jan. 8, 2014 and to which application we claim priority under 35 U.S.C. §120, which claims the benefit of U.S. Provisional Application No. 61/750,229, filed Jan. 8, 2013, the contents of which applications are incorporated herein by reference in their entirety.

### BACKGROUND

Natural gas is a consideration as an alternative fuel for vehicles. In a natural gas-powered vehicle, a container or fuel tank is used to hold and transport the natural gas for the vehicle. Such tanks need to be refilled. In many instances, these tanks should be filled to an optimal, maximum capacity to optimize the range of a natural gas-powered vehicle.

To detect whether a tank has been fully filled, a fuel station typically has pressure control logic that stops the filling of the tank when pressure within the tank has reached a threshold level, typically 3,600 psi. During the fueling process, heat is generated within the cylinder. This heat buildup is commonly referred to as heat of compression. In at least some instances, the tank absorbs heat due to heat of compression when a fuel tank is filled with natural gas. This heat may cause the pressure control logic on the fuel station to shut down as if the pressure within the tank were at the threshold level, e.g., 3,600 psi. Once the tank cools, the pressure in the tank can drop by hundreds of psi and reduce driving range for the customer. In other words, in current methods of filling a natural gas tank, heat of compression while filling can cause the pressure control logic to misreport the mass or energy content of the fuel within the tank such that it is filled below its optimal, maximum capacity. To compensate, some fast-fill type compressed natural gas fuel stations may fill a fuel tank to 4,300 psi to over pressurize the tank before the tank cools down so that pressure settles to 3,600 psi. Over-pressurization, however, is less than ideal in many circumstances. Thus, there is a need for improved methods, systems, and devices for filling fuel tanks, particularly natural gas fuel tanks.

### SUMMARY

Aspects of the invention provide improved methods, systems, and devices for filling fuel tanks In particular, improved methods, systems, and devices are provided for reducing or channeling away heat generated as a fuel tank is being filled. According to many embodiments, the heat generated by filling of the fuel tank can be reduced or channeled away by separating fuel input into a cooled fuel stream and a warmer fuel stream or by modifying the flow characteristics of the fuel as it is released into the interior of the fuel tank. For instance, the temperature increase of the fuel tank due to the heat generated may be reduced by at least 5%, 10%, 15%, 20%, 25%, 30%, 35%, 40%, 45%, 50%, 55%, 60%, 65%, 70%, 75%, 80%, 85%, 90%, or 95% by the various systems, devices, and methods described herein. By reducing or channeling away from the fuel tank the heat generated, the pressure control logic on a fuel filling station will be able to make more accurate readings for the actual amount of fuel and energy stored within the fuel tank. Accordingly, the fuel tank can be filled to its optimal, maximum capacity or improved, increased capacities, increasing the driving range of the vehicle. Such methods, systems, and devices are particularly suitable for compressed natural gas (CNG) and compressed natural gas (CNG) fuel tanks but may also be suitable for other fuels, including liquefied natural gas (LNG), liquefied petroleum gas (LPG), Diesel fuel, gasoline, dimethyl ether (DME), methanol, ethanol, butanol, Fischer-Tropsch (FT) fuels, hydrogen or hydrogen-based gas, hythane, HCNG, syngas, and/or other alternative fuels of fuel blends, and their fuel tanks.

An aspect of the invention provides a method of filling a fuel tank. A fuel tank comprising a fuel inlet and defining a hollow interior for fuel storage is provided. Fuel is delivered past the fuel inlet, through a flow modification element, and into the hollow interior of the fuel tank to fill the fuel tank. The flow modification element causes the fuel tank to be filled such that heat rejection or transfer away from the fuel is enhanced, reducing the temperature increased caused by filling of the fuel tank. For instance, the temperature increase of the fuel tank due to the heat generated may be at least 5%, 10%, 15%, 20%, 25%, 30%, 35%, 40%, 45% 50%, 55%, 60%, 65%, 70%, 75%, 80%, 85%, 90%, or 95% less. Typically, the flow modification element will direct the delivered fuel to flow in a vortex manner within the fuel tank. The delivered fuel will typically be compressed natural gas (CNG) and the fuel tank may be a compressed natural gas (CNG) tank.

The flow modification element may be integral with the fuel tank or comprise an insert that is to be placed within the hollow interior of the fuel tank. Where the flow modification element is integral with the fuel tank, the flow modification element may comprise one or more channels configured to direct the delivered fuel to flow in a vortex and/or radial manner within the fuel tank. These one or more channels will typically be at least partially helical. Alternatively or in combination, the flow modification element may comprise a straight tube drilled with hole(s) to introduce the fuel radially outward from the hole(s). Where the flow modification element comprises an insert, the insert may comprise a fuel inlet adapted to couple to the fuel inlet of the fuel tank and a fuel outlet for releasing fuel into the hollow interior of the fuel tank to fill the fuel tank. The insert may comprise at least one of a straight tube, a helical tube, a twisted tape, and a helical vane. The flow modification element may also be an external component that is coupled to the fuel inlet of the fuel tank. For example, the external component may be a Ranque-Hilsh vortex tube adapted to be coupled to the fuel inlet of the fuel tank. This Ranque-Hilsh vortex tube may be configured to separate a stream of fuel into a cooled stream that is delivered into the fuel tank to fill the tank and a warmer stream that is delivered back to the fuel station, a separate fuel cooling device, or the like.

Another aspect of the invention provides a system for storing fuel. The system comprises a fuel tank and a flow modification instrument. The fuel tank comprises a fuel inlet and defines a hollow interior for fuel storage. The flow modification element is adapted to be coupled to the fuel tank. When the fuel tank is filled, the flow modification element causes the fuel tank to be filled such that heat rejection or transfer away from the fuel is enhanced, reducing the temperature increase caused by filling of the fuel tank. For instance, the temperature increase of the fuel tank due to the heat generated may be at least 5%, 10%, 15%, 20%, 25%, 30%, 35%, 40%, 45%, 50%, 55%, 60%, 65%, 70%, 75%, 80%, 85%, 90%, or 95% less. The fuel tank may specifically be adapted to store compressed natural gas (CNG) and be a compressed natural gas (CNG) tank.

The flow modification element may be an insert adapted to be placed within the fuel tank. The insert comprises a fuel inlet end and a fuel outlet end. The fuel inlet end is adapted to couple to the fuel inlet of the fuel tank and the fuel outlet end releases fuel into the interior of the fuel tank to fill the fuel tank. The insert may comprise at least one of a straight tube, a helical tube, a twisted tape, and a helical vane. The flow modification element may also be a Ranque-Hilsh vortex tube as described above.

A further aspect of the invention provides a fuel tank comprising a fuel inlet, a fuel storage chamber, and a flow modification element. The flow modification element is disposed between the fuel inlet and the fuel storage chamber. When the fuel tank is filled, the flow modification element causes the fuel tank to be filled such that heat rejection or transfer away from the fuel is enhanced, reducing the temperature increased caused by filling of the fuel tank. For instance, the temperature increase of the fuel tank due to the heat generated may be at least 5%, 10%, 15%, 20%, 25%, 30%, 35%, 40%, 45%, 50%, 55%, 60%, 65%, 70%, 75%, 80%, 85%, 90%, or 95% less. The flow modification element will typically be integral with the fuel tank. Alternatively, the flow modification element may be a separate component that is coupled to the interior of the fuel tank. The flow modification element may comprise one or more channels configured to direct fuel delivered from the fuel inlet to flow in a vortex manner within the fuel storage chamber. These channels may be at least partially helical. Typically, the fuel tank comprises a compressed natural gas (CNG) tank.

Aspects of the present disclosure provide a fuel tank which may comprise a fuel storage chamber and a heat sink. The fuel storage chamber may have a fuel storage chamber wall defining an interior volume. The heatsink may be coupled to the fuel storage chamber wall. The heatsink may comprise an interior heatsink portion disposed within the interior volume of the fuel storage chamber and an exterior heatsink portion exposed to an exterior of the fuel storage chamber wall to facilitate heat transfer between the interior volume and the exterior of the fuel storage chamber wall. The fuel storage chamber may be configured to store and maintain pressure for compressed natural gas (CNG).

The fuel tank may further comprise a fuel inlet coupled to the fuel storage chamber wall. The fuel inlet may be disposed on a first side of the fuel storage chamber wall as well as on a second side of the fuel storage chamber wall. The first side of the fuel storage chamber wall may be opposite the second side of the fuel storage chamber wall.

The fuel tank may further comprise a flow modification element coupled to the fuel inlet. When the fuel storage chamber is filled with a fuel, the flow modification element may cause the fuel storage chamber to be filled such that heat rejection or transfer away from the fuel is enhanced, reducing the temperature increased caused by filling of the fuel tank. For instance, the temperature increase of the fuel tank due to the heat generated may be at least 5%, 10%, 15%, 20%, 25%, 30%, 35%, 40%, 45%, 50%, 55%, 60%, 65%, 70%, 75%, 80%, 85%, 90%, or 95% less. The flow modification element may be disposed at least partially within the interior volume of the fuel storage chamber when coupled to the fuel inlet. The flow modification element may be configured to outlet the fluid into a middle portion of the interior volume of the fuel storage chamber when the fuel storage chamber is filled with the fuel. The flow modification element may be integral with the fuel tank. The flow modification element may be removably attached to the fuel inlet such as to an exterior of the fuel inlet. The flow modification element may be configured to direct the fuel to flow in a vortex manner within the interior volume of the fuel storage chamber. The flow modification element may comprise a vortex channel configured to direct the fuel. The vortex channel may be at least partially helical.

The interior heat sink portion may be integral with the exterior heat sink portion. The heatsink may further comprise a heatsink wall portion coupling the interior heatsink portion with the exterior heatsink portion. The heatsink wall portion may be coupled to the fuel storage chamber wall. The interior heatsink portion may comprise at least one interior fin. The at least one interior fin may comprise a plurality of interior fins. The at least one interior fin may comprise a heat conductive metal. The heat conductive metal of the interior heatsink portion may comprise one or more of aluminum, copper, copper-tungsten alloy, AlSiC (silicon carbide in aluminum matrix), Dymalloy (diamond in copper-silver alloy matrix), E-Material (beryllium oxide in beryllium matrix), or combinations thereof.

The exterior heatsink portion may comprise at least one exterior fin. The at least one exterior fin may comprise a plurality of exterior fins. The at least one exterior fin may be configured to be cooled by at least one of ambient air, ambient fluid, a fan directing air to the at least one exterior fin, a fan directing fluid to the at least one exterior fin, or a coolant system. The at least one exterior fin may comprise a heat conductive metal. The heat conductive metal of the exterior heatsink portion may comprise one or more of aluminum, copper, copper-tungsten alloy, AlSiC (silicon carbide in aluminum matrix), Dymalloy (diamond in copper-silver alloy matrix), E-Material (beryllium oxide in beryllium matrix), or combinations thereof.

Aspects of the present disclosure also provide a system for storing fuel. The system comprises a fuel tank as described herein and an active cooling element for cooling the exterior heatsink portion of the fuel tank. The active cooling element may comprise at least one of a fluid bath, a fan, or a coolant system.

Aspects of the present disclosure also provide a method of filling a fuel tank with fuel. A fuel tank comprising a fuel inlet, a fuel storage chamber having a wall defining an interior volume, and a heatsink coupled to the wall may be provided. The heatsink may be disposed within the interior volume and exposed to an exterior of the wall. Fuel may be introduced into the interior volume through the fuel inlet. The introduction of the fuel can generate a heat of compression. The heatsink may direct at least a portion of the generated heat of compression from the interior volume to the exterior of the wall of the fuel storage chamber.

The fuel may be introduced into the interior volume by channeling the fuel through a flow modification element. The flow modification element may cause the fuel tank to be filled such that heat rejection or transfer away from the fuel is enhanced, reducing the temperature increased caused by filling of the fuel tank. For instance, the temperature increase of the fuel tank due to the heat generated may be at least 5%, 10%, 15%, 20%, 25%, 30%, 35%, 40%, 45%, 50%, 55%, 60%, 65%, 70%, 75%, 80%, 85%, 90%, or 95% less. The fuel through the flow modification element may cause the fuel to flow into the interior volume in a vortex manner. The fuel may be channeled through the flow modification element by introducing the fuel into a middle portion of the interior volume. The flow modification element may be coupled to the fuel inlet.

Aspects of the present disclosure also provide a fuel tank which may comprise a fuel storage chamber, a fuel flow channel, and a heat exchanger. The fuel storage chamber may have a fuel storage chamber wall defining an interior volume. The fuel storage chamber may have a fuel inlet and a fuel outlet. The fuel flow channel may be connected to one or more of the fuel inlet or the fuel outlet of the fuel storage chamber. The fuel flow channel may be configured to have fuel from the interior volume of the fuel storage chamber flowing therein. The heat exchanger may be coupled to the fuel flow channel and configured to cool the fuel flow channel and the fuel flowing therein. The fuel storage chamber may be configured to store and maintain pressure for compressed natural gas (CNG).

The fuel flow channel may comprise an external portion disposed at least partially external of the fuel storage chamber wall. The heat exchanger may be coupled to the external portion of the fuel flow channel. The external portion of the fuel flow channel coupled to the heat exchanger may comprise one or more of a coiled portion, a greater external surface area portion, a finned portion, or a thinner wall portion of the fuel flow channel.

The heat exchanger may comprise one or more of a fan, an air fan, a liquid cooling system, a water cooler, or a heat sink. The fuel flow channel may comprise a heat conductive material. The heat conductive metal comprises one or more of aluminum, copper, copper-tungsten alloy, AlSiC (silicon carbide in aluminum matrix), Dymalloy (diamond in copper-silver alloy matrix), E-Material (beryllium oxide in beryllium matrix), or combinations thereof.

The fuel flow channel may comprise an internal portion disposed at least partially within the interior volume of the fuel storage chamber. The internal portion may be configured to allow heat to diffuse between fuel stored in the interior volume of the fuel storage chamber and fuel flowing through the internal portion of the fuel flow channel. The internal portion of the fuel flow channel disposed at least partially within the interior volume of the fuel storage chamber may comprise one or more of a coiled portion, a greater surface area portion, a finned portion, or a thinner wall portion of the fuel flow channel.

The fuel tank may further comprise a pump coupled to the fuel flow channel to pump the fuel flowing therein. The fuel tank may further comprise a flow modification element coupled to the fuel inlet. When the fuel storage chamber is filled with fuel, the flow modification element may cause the fuel storage chamber to be filled such that heat rejection or transfer away from the fuel is enhanced, reducing the temperature increased caused by filling of the fuel tank. For instance, the temperature increase of the fuel tank due to the heat generated may be at least 5%, 10%, 15%, 20%, 25%, 30%, 35%, 40%, 45%, 50%, 55%, 60%, 65%, 70%, 75%, 80%, 85%, 90%, or 95% less. The flow modification element may be disposed at least partially within the interior volume of the fuel storage chamber. The flow modification element may be configured to direct the fuel to flow in a vortex manner within the interior volume of the fuel storage chamber.

Aspects of the present disclosure also provide a method of filling a fuel tank with fuel. A fuel tank comprising a fuel storage chamber having a wall defining an interior volume, a fuel inlet, a fuel outlet, and a fuel flow channel coupled to one or more of the fuel inlet or fuel outlet may be provided. Fuel may be flowed through the fuel flow channel. The fuel disposed within the interior volume of the fuel storage chamber may be cooled.

The fuel disposed within the interior volume of the fuel storage chamber may be cooled by cooling at least a portion of the fuel flow channel to cool the fuel flowing therein. The cooled fuel may be introduced into the interior volume of the fuel storage chamber. The portion of the fuel flow channel may be cooled by flowing a fluid over the exterior of the portion of the fuel flow channel. The fluid may be flowed over the exterior of the portion of the fuel flow channel by blowing air from a fan over the exterior of the portion of the fuel flow channel. The fluid may be flowed over the exterior of the portion of the fuel flow channel by circulating liquid over the exterior of the portion of the fuel flow channel.

The fuel disposed within the interior volume of the fuel storage chamber may be cooled by passing at least a portion of the fuel flow channel through the interior volume of the fuel storage chamber and allowing heat to diffuse between fuel stored in the interior volume of the fuel storage chamber and fuel flowing through the portion of the fuel flow channel.

The fuel may further be channeled through a flow modification element before introducing the fuel into interior volume of the fuel storage chamber. The flow modification element may cause the fuel storage chamber to be filled such that heat rejection or transfer away from the fuel is enhanced, reducing the temperature increased caused by filling of the fuel tank. For instance, the temperature increase of the fuel tank due to the heat generated may be at least 5%, 10%, 15%, 20%, 25%, 30%, 35%, 40%, 45%, 50%, 55%, 60%, 65%, 70%, 75%, 80%, 85%, 90%, or 95% less. The flow modification element may be disposed at least partially within the interior volume of the fuel storage chamber. The flow modification element may be configured to direct the fuel to flow in a vortex manner within the interior volume of the fuel storage chamber. The fuel may comprise compressed natural gas (CNG).

Additional aspects and advantages of the disclosure will become readily apparent to those skilled in this art from the following detailed description, wherein only illustrative embodiments of the present disclosure are shown and described. As will be realized, the present disclosure is capable of other and different exemplary implementations, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a perspective view of a fuel tank with a section cut out for the purpose of illustration.

FIG. 1B is a cross-sectional view of the fuel tank of FIG. 1A.

FIG. 2 is a graph showing the temperature profile of a fuel tank as it is being filled.

FIG. 3 is a cross-sectional view of a fuel tank coupled with a fuel flow modification insert, according to various embodiments.

FIG. 4 is a graph showing the temperature profile of a fuel tank coupled with a fuel flow modification insert as the tank is being filled;

FIG. 5A is a side view of a helical flow modification insert, according various embodiments.

FIG. 5B is a cross-sectional view of a fuel tank coupled with a helical flow modification insert.

FIG. 5C is a side view of another helical flow modification insert, according to various embodiments.

FIG. 6A is a cross-sectional view of a fuel tank coupled with a flow modification insert having a flow modification portion, according to various embodiments.

FIG. 6B is a side, cross-sectional view of a flow modification portion (e.g., of FIG. 6A) comprising a twisted tape, according to various embodiments.

FIG. 6C is a side, cross-sectional view of a flow modification portion (e.g., of FIG. 6A) comprising a screw winding, according to various embodiments.

FIG. 6D is a side, cross-sectional view of a flow modification portion (e.g., of FIG. 6A) comprising a static mixer, according to various embodiments.

FIG. 7 is a cross-sectional view of a fuel tank coupled with a Ranque-Hilsh vortex tube, according to various embodiments.

FIG. 8 is a cross sectional view of a fuel tank having an internal fuel flow modification structure, according to various embodiments.

FIG. 9A is a cross sectional view of a fuel tank having a parallel heat path, according to various embodiments.

FIG. 9B is a schematic diagram of the heat transfer circuit of the fuel tank of FIG. 9A.

FIG. 10A is a cross sectional view of a fuel tank having both a fuel flow modification insert or structure and a heat sink, according to various embodiments.

FIG. 10B is a cross sectional view of another fuel tank having both a fuel flow modification insert or structure and a heat sink, according to various embodiments.

FIG. 10C is a cross sectional view of a fuel tank having a heat pipe, according to various embodiments.

FIG. 11 is a cross sectional view of a fuel tank having a heatsink with radial fins, according to various embodiments.

FIG. 11A is a cross sectional view of the fuel tank of FIG. 11 taken along line 11A in FIG. 11.

FIG. 12 is a cross sectional view of a fuel tank having a heat sink in the form of a liner, according to various embodiments.

FIG. 13 is a cross sectional view of a fuel tank having a heat sink having removable and user selectable internal and external fin(s), according to various embodiments.

FIG. 14 is a cross sectional view of an end of a fuel tank having a heat sink plate, according to various embodiments.

FIG. 15A is a cross sectional view of a fuel tank having an active cooling system, according to various embodiments.

FIG. 15B is a schematic diagram of the heat transfer circuit of the fuel tank of FIG. 15A.

FIG. 16A is a cross sectional view of a fuel tank having a fuel inflow powered cooling system, according to various embodiments.

FIG. 16B is a cross sectional view of a fuel tank having a coiled inflow piping, according to various embodiments.

FIG. 16C is a cross sectional view of a fuel tank having an external, liquid-based heat exchanger, according to various embodiments.

FIG. 17A is a cross sectional view of a fuel tank having an internally finned and externally coiled and cooled piping, according to various embodiments.

FIG. 17B is a schematic diagram of the heat transfer circuit of the fuel tank of FIG. 17A.

FIG. 18A is a cross sectional view of fuel tank having a venturi inlet and an external heat exchanger, according to various embodiments.

FIG. 18B is schematic, cross sectional diagram of the venturi inlet of FIG. 18A.

FIG. 19 is a cross sectional view of a fuel tank having a fuel flow modification insert, a heat sink, and piping leading to a heat exchanger and back into the fuel tank interior chamber, according to various embodiments.

FIG. 20 is a cross sectional view of a fuel tank having a swirling inlet attachment, a coiled piping to circulate fuel through the fuel tank interior chamber and drive the swirling inlet attachment, and a heat exchanger, according to various embodiments.

FIGS. 20A to 20C show a front, a side sectional, and a perspective view, respectively, of the swirling inlet attachment of FIG. 20.

FIGS. 21A and 21B show side and cross-sectional views, respectively, of a fuel tank having a cooling blanket wrapped around the body of the fuel tank.

FIGS. 22A and 22B show side and cross-sectional views, respectively, of a fuel tank having a cooling coil wrapped around the body of the fuel tank.

FIGS. 23A and 23B show schematics of a heat pipe thermal cycle which may be used to facilitate the cooling of compressed gas in fuel tanks, according to many embodiments.

FIG. 24 shows various heat sinks which may be used to facilitate the cooling of compressed gas in fuel tanks, according to many embodiments.

FIGS. 25A and 25B show various examples of high pressure tubing which may be used for gas cooling systems to facilitate the cooling of compressed gas in fuel tanks, according to many embodiments.

FIGS. 26A, 26B, and 26C show heat sinks which may be used to facilitate the cooling of compressed gas in fuel tanks, according to many embodiments.

FIGS. 27A, 27B, and 27C show perspective views of an exemplary, noise reducing and/or heat rejection enhancing fuel inlet insert, according to many embodiments.

FIGS. 28A and 28B show perspective and section views, respectively, of a further noise reducing and/or heat rejection enhancing fuel inlet insert, according to many embodiments.

FIG. 29 shows a section view of a further noise reducing and/or heat rejection enhancing fuel inlet insert, according to many embodiments.

FIG. 30 shows a section view of a further noise reducing and/or heat rejection enhancing inlet insert, according to many embodiments.

### DETAILED DESCRIPTION

Aspects of the invention provide improved methods, systems, and devices for filling fuel tanks. In particular, improved methods, systems, and devices are provided for providing enhanced rejection of the heat generated by the filling a fuel tank. Various aspects of the invention described herein may be applied to any of the particular applications set forth below or for any other types of gaseous fuel monitoring systems. Aspects of the invention may be applied as a standalone system or method, or as part of a vehicle, vehicle fuel tank, or other system that utilizes gaseous or other fuel. Such vehicle fuel tanks include those mounted on vehicles, such as cars, wagons, vans, heavy duty vehicles, buses, high-occupancy vehicles, dump trucks, tractor trailer trucks, or other vehicles. The fuel tank may be mounted in many ways including but not limited to side mounting, roof mounting, and rear mounting. According to embodiments of the invention, these fuel tanks may be filled while mounted on the vehicle or filled before being mounted on the vehicle. It shall be understood that different aspects of the invention can be appreciated individually, collectively, or in combination with each other.

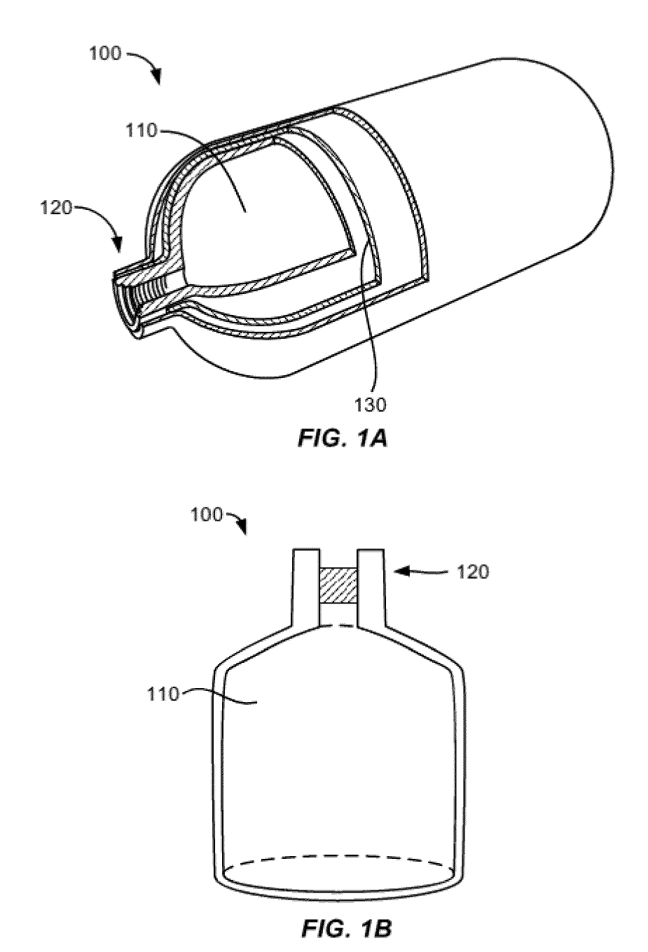

FIG. 1A is a perspective view of a fuel tank 100 with a section cut out for the purpose of illustration. The fuel tank 100 is configured to be filled with and store compressed natural gas (CNG). The fuel tank 100 may also be instead configured to be filled with other fuels such as liquefied natural gas (LNG), liquefied petroleum gas (LPG), Diesel fuel, gasoline, dimethyl ether (DME), methanol, ethanol, butanol, Fischer-Tropsch (FT) fuels, hydrogen or hydrogen-based gas, hythane, HCNG, syngas, and/or other alternative fuels of fuel blends. Where the filled fuel is gaseous, the fuel tank may be capable of containing a fuel having less than or equal to about 10000 psi, 8000 psi, 7000 psi, 6000 psi, 5500 psi, 5000 psi, 4750 psi, 4500 psi, 4250 psi, 4000 psi, 3750 psi, 3500 psi, 3250 psi, 3000 psi, 2750 psi, 2500 psi, 2000 psi, 1500 psi, 1000 psi, 500 psi, 300 psi, 100 psi, or less.

As shown in FIG. 1A, fuel tank 100 is cylindrical and comprises a hollow interior 110, a fuel inlet element 120, and a reinforced, insulated wall 130. The wall 130 is built to withstand high pressures when the tank 100 is filled with compressed natural gas as well as to maintain the temperature of the stored fuel. The fuel tank inlet element 120 is adapted to be coupled with fuel sources such as the typical fuel filling pumps, particularly CNG filling pumps, found in fuel stations. FIG. 1B shows a cross-sectional view of the fuel tank 100, emphasizing the hollow interior 110 which stores the fuel delivered into the tank 100.

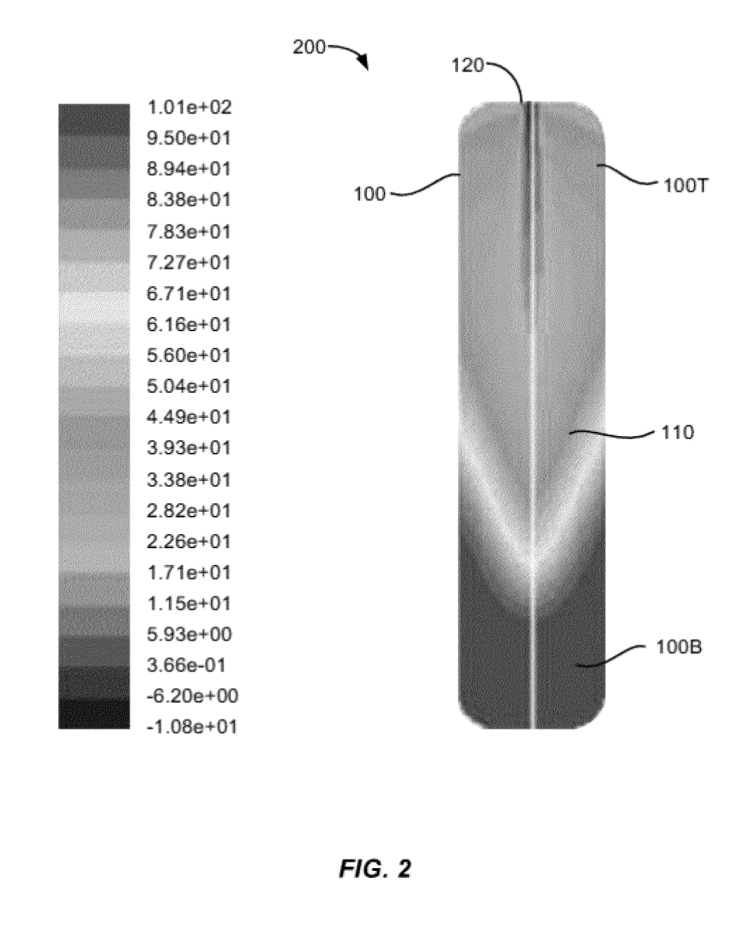

FIG. 2 is a graph 200 showing the temperature profile of the fuel tank 100. As shown in the graph 200, fuel is released into the interior 110 of the fuel tank 100 from an opening in the fuel inlet element 120 at the top portion 100T of the tank 100 as in many current conventional methods. Initially for a relatively unfilled tank 100, natural gas released from the fuel inlet element 120 decreases in temperature because it is released into the lower pressure environment of the interior 110 from a higher pressure, compressed environment from the fuel station pump. As the tank 100 starts becoming more filled, it becomes more pressurized and the temperature of the gas within the fuel tank 100 may increase, starting with the bottom portion 100B of the tank as shown in graph 200. This heat of compression often causes the pressure control logic on a fuel station or a fuel station pump to report inaccurate readings, particularly inaccurate readings of the amount of fuel delivered into the tank 100 such as the reported mass and pressure of the fuel delivered. For example, a fuel tank 100 that has an optimal capacity of 3,600 psi may be filled up to when pressure in the tank reaches 3,600 psi. As the fuel in the tank 100 returns to a normal, vehicle operating temperature, pressure will often drop by hundreds of psi. This drop in psi means that the tank 100 was filled below capacity even if the pressure control logic otherwise showed that the tank 100 was filled to capacity. Accordingly, a vehicle using the fuel tank 100 filled with this method may often be driving with a less than optimal and less than maximum range.

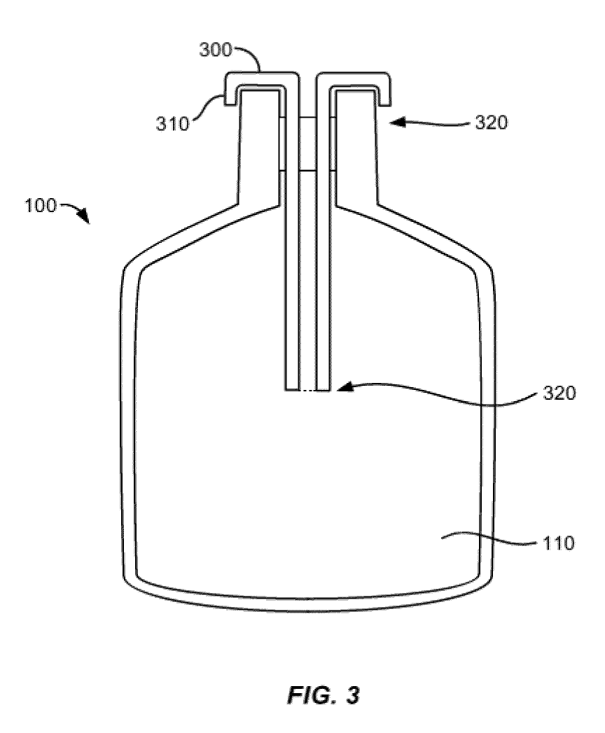

Aspects of the invention provide methods, systems, and devices for filling fuel tanks such that rejection or transfer away of this heat of compression is enhanced. FIG. 3 is a cross-sectional view of the fuel tank 100 coupled with a fuel flow modification insert 300. The fuel flow modification insert 300 may comprise a long, cylindrical tube. The fuel flow modification insert 300 may be configured in other ways, such as by having an elliptical, triangular, rectangular, square, or other polygonal cross-section. Passage through the insert 300 lengthens the flow path for the fuel and can increase the laminar quality of the flow. Alternatively, the insert 300 may be configured in a way to increase the turbulence of the flow if so desired.

The insert 300 can be coupled to the fuel inlet element 120 at top portion 310. For example, the fuel inlet element 120 and the top portion 310 may both comprise threads such that the fuel flow modification insert 300 may be screwed onto the fuel inlet element 120. The insert 300 may also couple to the fuel tank 100 in various other ways such as by using snap fasteners or friction locking mechanisms. The top portion 310 of the insert 300 can also couple to a fuel filling pump. The fuel flow modification insert 300 ends at an opening 320. Fuel is released into the interior 110 of the tank 100 at the opening 320 which as shown in FIG. 3 is positioned in the middle of the interior 110 of the tank 100. In some instances, the opening may be disposed at other locations in the interior 110 of the tank 100, for example about 10%, 20%, 30%, 40%, 60%, 70%, 80%, and 90% of the way into the tank 100.

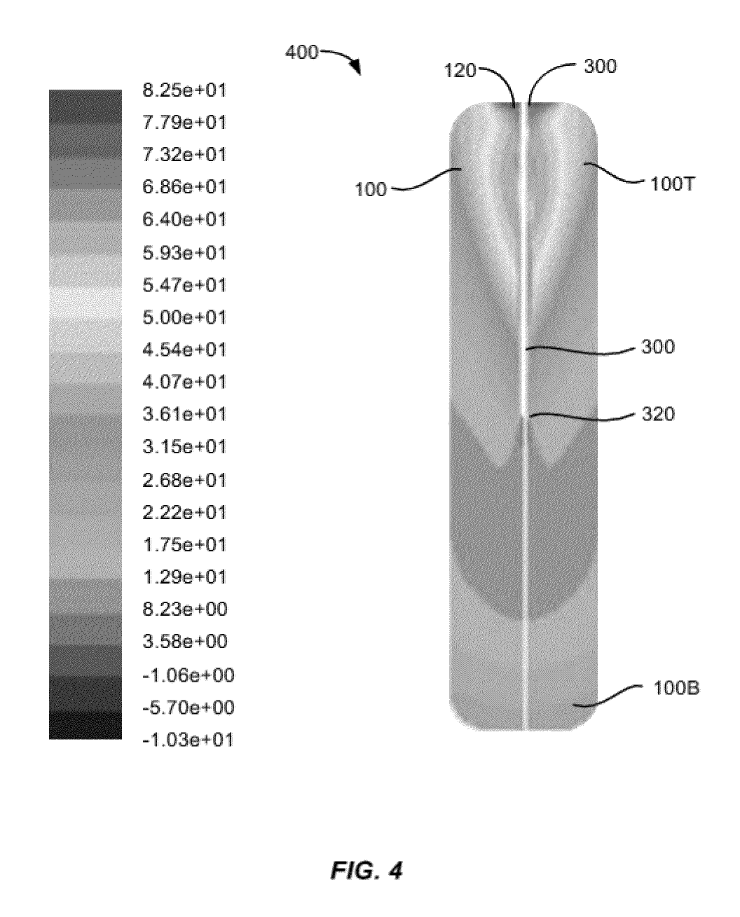

Releasing fuel into the interior 110 of the tank 100 at the middle of the interior 110 of the tank instead of the top 100T may enhance heat rejection. FIG. 4 is a graph 400 showing the temperature profile of a fuel tank 100 coupled with the fuel flow modification insert 300 as the tank is being filled. As shown in the graph 400, the temperature of the fuel within the interior 110 is cooler and more uniform where fuel is released from the middle of the interior 110 of the tank versus where the fuel release point is at the top end 110T of the tank 100. Because heat transfer or rejection is enhanced, the fuel has a lower temperature with less heat-based expansion and pressure control logic can more accurately gage the current fuel level of the tank 100 as it is being filled. Thus, a reading that the tank 100 is full will more accurately reflect the fact that the tank 100 is indeed at full capacity once the gas within the tank 100 is at a normal, vehicle operating temperature.

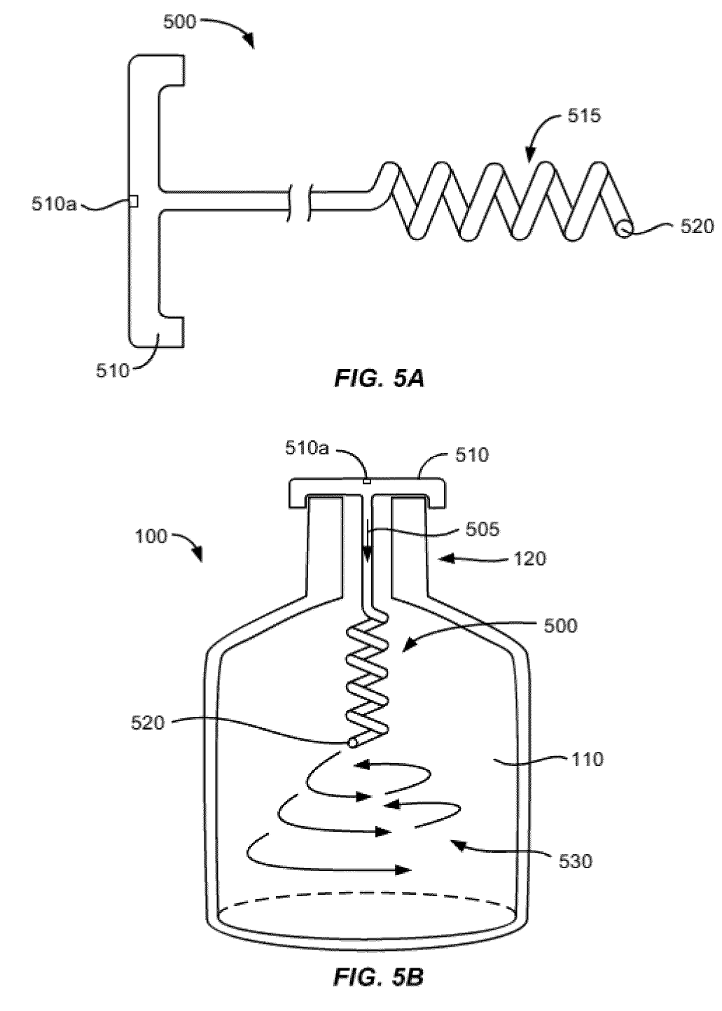

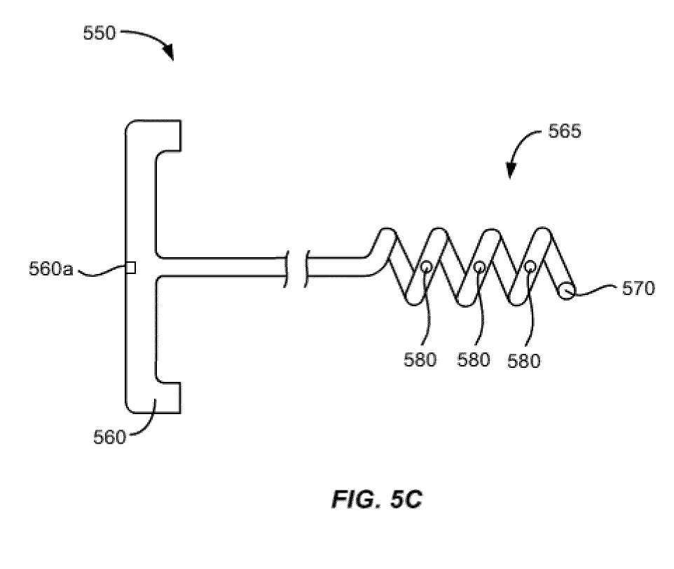

Various other types and arrangements can also be used to enhance heat rejection. FIG. 5A is a side view of a helical flow modification insert 500 according various embodiments. The insert 500 can be similar to insert 300 or share one or more common features with insert 300. Instead of comprising a long, straight middle portion, however, the insert 500 comprises a helical portion 515. The insert 500 comprises a top, inlet portion 510 adapted to couple to the fuel inlet element 120 of the tank 100 as shown in FIG. 5B. The insert 500 may couple to the tank 100 by various ways as described above. A fuel pump nozzle may couple to a port 510a in the inlet portion 510 of the insert 500 to introduce fuel into the hollow insert 500 as shown by arrow 505. As the fuel travels through the insert 500, the laminar quality of the fuel flow may increase and the fuel passes through the helical portion 515 and is released at end port 520. The released fuel continues its directionality of movement such that it is released into the interior 110 of the tank in a vortex manner as shown by arrows 530. By having the fuel move in a vortex manner within the tank, the heat distribution of the fuel can be more evenly distributed such that heat rejection or transfer away from the fuel and/or the fuel tank will be enhanced. For instance, the heat of compression may be at least 5%, 10%, 15%, 20%, 25%, 30%, 35%, 40%, 45%, 50%, 55%, 60%, 65%, 70%, 75%, 80%, 85%, 90%, or 95% less. As discussed above and herein, because heat rejection is enhanced, pressure control logic can more accurately gage the current fuel level of the tank 100 as it is being filled. Thus, a reading that the tank 100 is full will more accurately reflect the fact that the tank 100 is indeed at full capacity once the gas within the tank 100 is at a normal, vehicle operating temperature. As shown in FIG. 5B, the insert 500 releases fuel at a location about 40% of the way into the interior 110 of the tank 100. The insert 500 may also be configured to release fuel into the interior 110 of the tank 100 at other locations, including not limited to about 10%, 20%, 30%, 50%, 60%, 70%, 80%, and 90% of the way into the tank 100.

FIG. 5C is a side view of another helical flow modification insert 550 according to various embodiments. The helical insert 550 is similar to the helical insert 500 described above. The insert 550 comprises a top, inlet portion 510 adapted to couple to the fuel inlet element 120 of the tank 100, an inlet port 560a in the inlet portion 560, a helical portion 565, and a fuel outlet end port 570. The helical portion 565 further comprises one or more side outlet ports 580 which like fuel outlet end port 570 also release fuel into the interior 110 of the fuel tank 100 in a vortex manner. A plurality of side outlet ports or perforations 580 may be spaced away from each other evenly or such that fuel is released from the insert 550 evenly throughout the interior 110 of the fuel tank 100. Advantageously, the plurality of side outlet ports or perforations 580 may significantly reduce the noise generated by the filling of the fuel tank 100 through the insert 550. For instance, the noise generated by the filling of the fuel tank 100 may be reduced by at least 5%, 10%, 15%, 20%, 25%, 30%, 35%, 40%, 45%, 50%, 55%, 60%, 65%, 70%, 75%, 80%, 85%, 90%, or 95% with the plurality of side outlets or perforations 580 compared to a helical insert 550 without the side outlets or perforations 580.

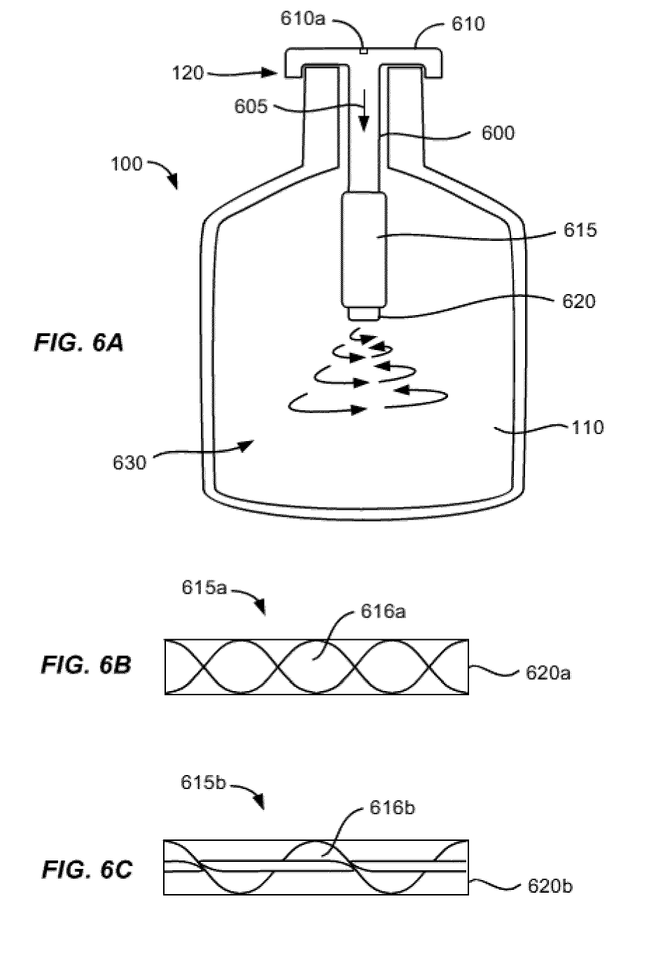

Various embodiments also provide various inserts that also release fuel into the interior 110 of the fuel tank 100 in a vortex manner. As shown in FIG. 6A, the fuel tank 100 may be coupled with a fuel flow modification insert 600. The insert 600 may couple with the fuel tank 100 in many ways. The insert 600 may comprise a top, fuel inlet portion 610 having an inlet port 610a; and, the inlet portion 610 couples to the inlet portion 120 of the tank 100. The insert 600 comprises a flow modification structure 615 which can increase the laminar quality of the fuel and releases fuel into interior 110 of the tank 100 in a vortex manner.

The flow modification structure 615 houses structural elements which modifies the flow characteristics of fuel passing through the structure 615. Some examples of these fuel flow modifying structural elements are shown in FIGS. 6B, 6C, and 6D.

FIG. 6B shows a side, cross-sectional view of a flow modification structure 615a that houses a twisted-tape 616a. The twisted tape 616a causes the straight, laminar flow of fuel passing through the flow modification structure 615a to rotate to some degree. Thus, fuel is released in a vortex manner from outlet port 620a.

FIG. 6C shows a side, cross-sectional view of a flow modification structure 615b that houses a screw winding 616b. The screw winding 616b causes the straight, laminar flow of fuel passing through the flow modification structure 615b to rotate to some degree. Thus, fuel is released in a vortex manner from outlet port 620b.

FIG. 6D shows a side, cross-sectional view of a flow modification structure 615c that comprises a static mixer. As fuel passes through the static mixer, a degree of rotation is added to the straight, laminar flow of fuel. Thus, fuel is released in a vortex manner from outlet port 620b.

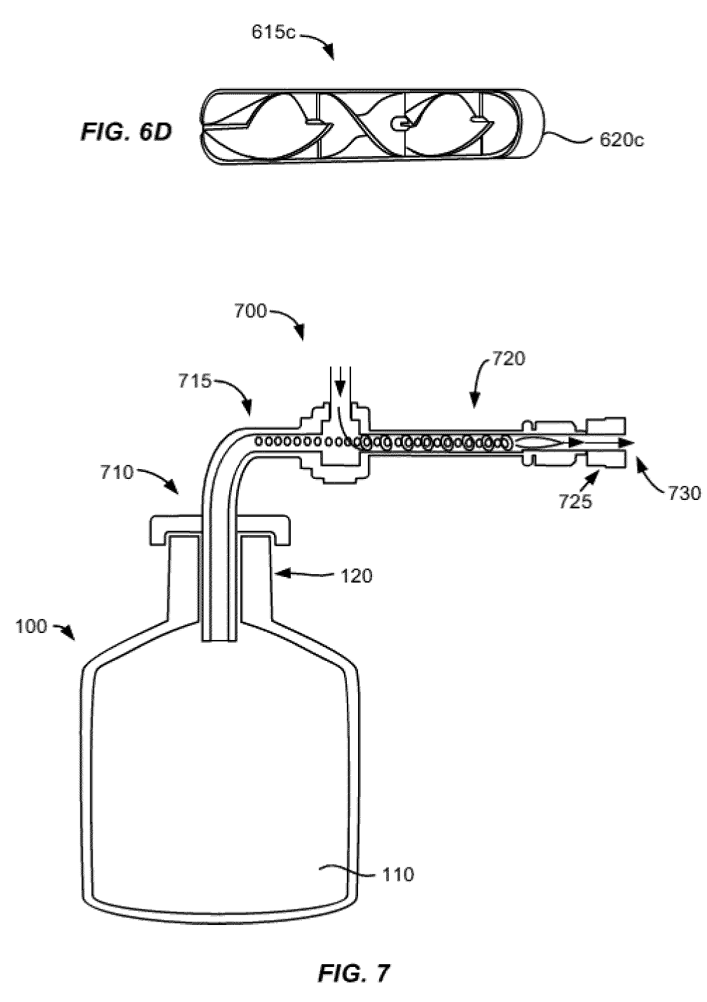

According to various embodiments, fuel may be pre-cooled before it is delivered into a fuel tank 100. For example, a Ranque-Hilsh vortex tube 700 as shown in FIG. 7 may be used to pre-cool fuel delivered into a fuel tank 100. FIG. 700 is a cross-sectional view of the fuel tank 100 coupled with the Ranque-Hilsh vortex tube 700. The vortex tube 700 comprises a fuel outlet portion 710 which can couple to inlet portion 120 of the fuel tank 100. The vortex tube 700 separates fuel flow into a cooled fuel stream 715 and a warmer fuel stream 720. The cooled fuel stream 715 is delivered into the interior of the fuel tank 100. The warmer fuel stream 720 exits the vortex tube 700 at an outlet port 730 and may be delivered to many locations, such as into a cooling device before being fed back into the fuel station tank or back into the vortex tube 700. The vortex tube 700 may further comprise a control valve 725 to control the warm fuel stream output of the vortex tube 700. By having the fuel delivered into the fuel tank 100 pre-cooled, the heat generated by filling of the tank may cause less of a temperature increase than if the fuel were delivered into the tank in a conventional manner. For instance, the temperature increase of the fuel tank due to the heat generated may be at least 5%, 10%, 15%, 20%, 25%, 30%, 35%, 40%, 45%, 50%, 55%, 60%, 65%, 70%, 75%, 80%, 85%, 90%, or 95% less. As discussed above and herein, because heat rejection is enhanced, pressure control logic can more accurately gage the current fuel level of the tank 100 as it is being filled. Thus, a reading that the tank 100 is full will more accurately reflect the fact that the tank 100 is indeed at full capacity once the gas within the tank 100 is at a normal, vehicle operating temperature.

According to various embodiments, a fuel tank itself may carry structures which modify fuel flow to enhance heat rejection. FIG. 8 is a cross sectional view of a fuel tank 800 comprising an internal fuel flow modification structure 820. The flow modification structure 820 may be integral, i.e., built into, the fuel tank 100. The fuel tank 800 comprises a fuel inlet portion 810 which may couple to a fuel station pump or nozzle to deliver fuel into the fuel tank 800 in a direction 811. The fuel tank 800 comprises a fuel storage chamber 830 which stores at least a majority of all the fuel delivered into the fuel tank 800. In order to enter the fuel storage chamber 830, fuel first passes through the flow modification structure 820 which releases fuel into the fuel storage chamber 830 in a vortex manner as described above to enhance heat rejection. The flow modification structure 820 comprises a performer 821 which directs fuel flow into one or more channels 822 of the flow modification structure 820. These one or more channels 822 may be at least partially helical or spiral to re-direct fuel to move in a vortex manner as it exits the fuel modification structure 820 and into the fuel storage chamber 830.

Aspects of the present disclosure may provide for parallel path(s) for heat to flow out of a fuel tank. This improved heat dissipation may lower the temperature and pressure of the fuel, which may allow the fuel tank to accept a greater total mass before reaching the limiting allowable pressure during fast filling or fueling.

The parallel path(s) for heat dissipation may be provided in many ways. In many embodiments, the parallel path(s) are provided by a heat sink or fin(s) comprising a highly conductive material with a high surface area that extends into the fuel storing interior of the fuel tank, passing through the wall or structural portion of the tank, and extending into the outside ambient air with additional heat sinks or fin(s). The external portion of the heat transfer surface may transfer heat to the surrounding environment in many ways. For example, heat may be dissipated through one or more of through passive convection, active convection, conduction, radiation, or the like. Active convection may involve the use of a fan or fluid pumping device to force air over the external fin(s). Heat from compression of gas within the interior of a fuel tank may be transferred to the highly conductive material of the heat sink or fin(s) efficiently because of the large surface area of the heat sink or fin(s) within the tank. Alternatively or in combination, a heat pipe may be used to passively remove heat. Alternatively or in combination, gas within the tank may be circulated internally or externally to increase convective heat transfer.

The heat sink or fin(s) may comprise any number or combination of highly heat conductive materials. Examples include but are not limited to aluminum, copper, copper-tungsten alloy, AlSiC (silicon carbide in aluminum matrix), Dymalloy (diamond in copper-silver alloy matrix), E-Material (beryllium oxide in beryllium matrix), or combinations thereof. The heat sink, heat fin(s), and/or active cooling element or fan for forced external convection may be integrated with the structural portions of the fuel tank during the fabrication process or may be deployed on tanks which cannot be internally modified such as those with inlet size limitations.

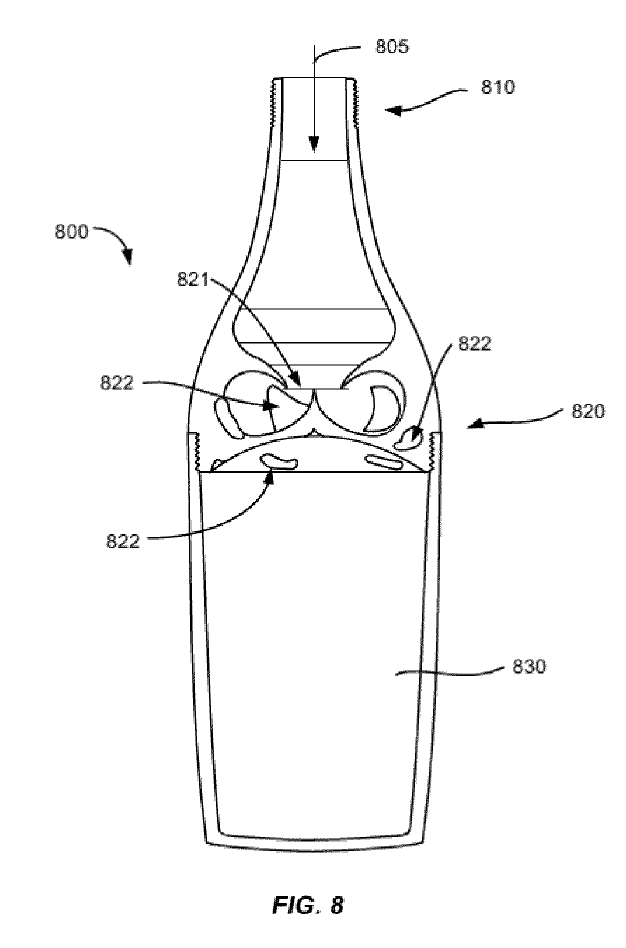

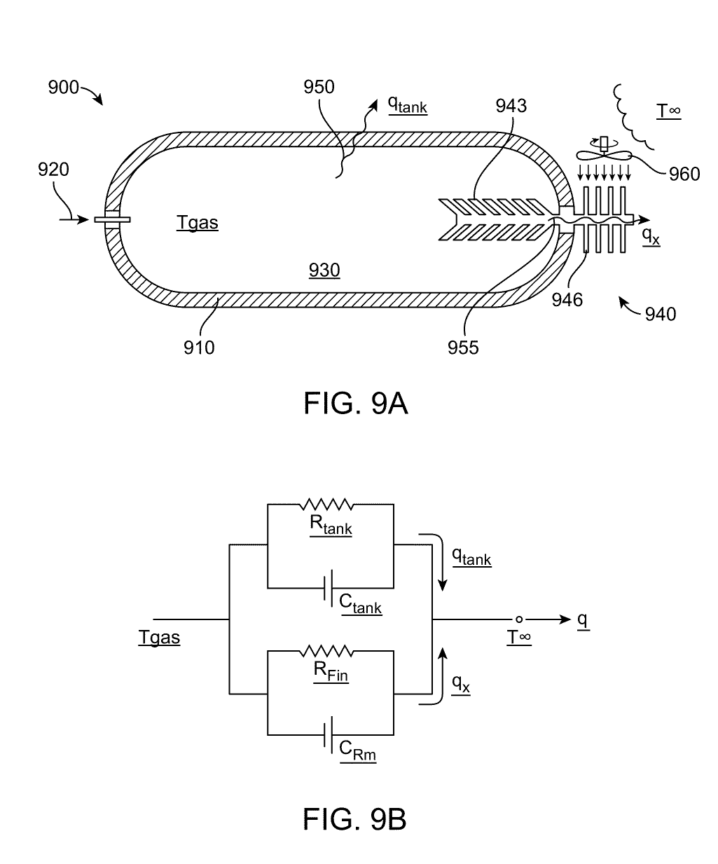

FIG. 9A shows a cross-sectional view of an exemplary fuel tank 900 having a parallel heat path in accordance with many embodiments. The fuel tank 900 may comprise a fuel tank wall 910, a fuel inlet 920 for compressed natural gas or other gas, an interior 930 for holding the pressurized gas which has a temperature T_{gas} within the interior 930, and a heat exchange element or heat sink 940. The heat sink 940 may traverse the fuel tank wall 910 and may comprise internal fin(s) 943 and external fin(s) 946. When the fuel tank 900 is filled, heat of compression may be generated. This and other heat may pass from the fuel tank interior 930 to the external environment through the fuel tank wall 910 as shown by arrow 950 with a flux qₜₐₙₖ. The heat may also pass from the fuel tank interior 930 to the external environment through the heat sink 940 as shown by arrow 955 with a flux qₓ. The air or gas in the external environment may have a temperature of T_{∞}. A fan 960 may be further provided to facilitate the cooling of the external fin(s) 946.

FIG. 9B shows a heat transfer circuit diagram of the fuel tank 900 having the parallel heat flow paths, where the heat form the gas in the fuel tank interior 930 having a temperature T_{gas} transfers to the external environment having heat or gas at a temperature T_{∞} with a total flux q. The total flux of q may comprise the sum of the flux qₜₐₙₖ of the heat flow directly through the fuel tank wall 910 and the flux qₓ of the heat flow through the heat sink 940. The fuel tank wall 910 may have a heat resistance Rₜₐₙₖ and a heat capacitance Cₜₐₙₖ. The heat sink 940 may have a heat resistance of R_{fin} and a heat capacitance C_{fin}. If Rₜₐₙₖ is less than R_{fin}, then qₓ may be greater than qₜₐₙₖ in stable conditions.

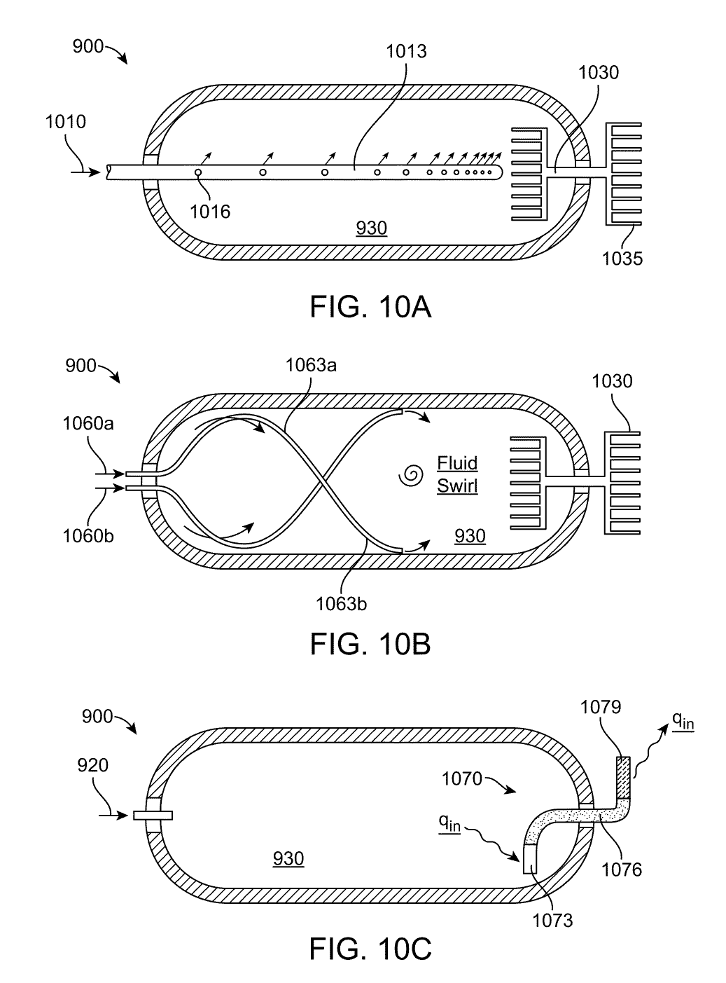

In many embodiments, a fuel inlet insert or flow modification structure may further be provided to enhance heat rejection. FIG. 10A shows the fuel tank 900 as having a fuel inlet structure 1010 which extends well into the interior volume 930 of the fuel tank 900. The flow modification structure 1010 may comprise a perforated tube 1013 having a plurality of outlet holes or perforations 1016 to allow gas to enter the fuel tank interior 930 more evenly. As shown in FIG. 10A, the outlet holes or perforations 1016 may be distributed along the length of the perforated tube 1013. Alternatively or in combination, the plurality of outlet holes 1016 may be arranged circumferentially about the longitudinal axis of the perforated tube 1013 to allow introduced fuel to be introduced radially outward from the tube 1013. Advantageously, the plurality of side outlet ports or perforations 1016 may significantly reduce the noise generated by the filling of the fuel tank 900 through the insert 1010. For instance, the noise generated by the filling of the fuel tank 900 may be reduced by at least 5%, 10%, 15%, 20%, 25%, 30%, 35%, 40%, 45%, 50%, 55%, 60%, 65%, 70%, 75%, 80%, 85%, 90%, or 95% with the plurality of side outlets or perforations 1016 compared to a flow modification structure 1010 without the side outlets or perforations 1016. FIG. 10B shows the fuel tank 900 as having a first flow modification structure 1060a and a second flow modification structure 1060b. The first flow modification structure 1060a may comprise a first vortex tube 1063a through which fuel can be introduced into the fuel tank interior 930 in a swirl or vortex manner. The second flow modification structure 1060b may comprise a second vortex tube 1063b through which fuel can be introduced into the fuel tank interior 930 in a swirl or vortex manner.

The fuel tank 900 may further comprise a heat sink 1030 to allow the gas within the fuel tank interior 930 to be further cooled. The heat sink 1030 may comprise a plurality of parallel fins 1035. As shown in FIGS. 10A and 10B, the fins may be oriented substantially parallel to the longitudinal axis of the fuel tank 900 or may be oriented transverse to the longitudinal axis as shown by the fins 943, 946 of the heat sink 940 in FIGS. 9A and 9B. And, the heat sink may traverse the wall 910 of the fuel tank 900.

As an alternative or an addition to having a heat sink, the fuel tank 900 may comprise a heat pipe 1070 to provide parallel heat transfer as shown in FIG. 10C. The heat pipe 1070 may comprise a liquid portion 1073, a vapor portion 1076, and a condensate portion 1079. The liquid portion 1073 may be disposed within the fuel tank interior 930 and generally has a higher temperature than the condensate portion 1079 which resides in the external environment of the tank 900. The liquid portion 1073 may absorb thermal energy from the fuel tank interior 930 which may cause at least some of the working fluid of the heat pipe 1070 to evaporate. Heat may transfer from the fuel tank interior 930 to the liquid portion 1073 of the heat pipe with a flux qᵢₙ. The vapor may migrate along the vapor portion 1076 to the condensate portion 1079 where the vapor may condense back to fluid and can be absorbed by a wick along the interior wall of the heat pipe 1070. The condensed working fluid may flow back to the higher temperature liquid portion 1073. Heat may transfer from the fuel tank exterior 1079 to the external environment with a flux qₒᵤₜ.

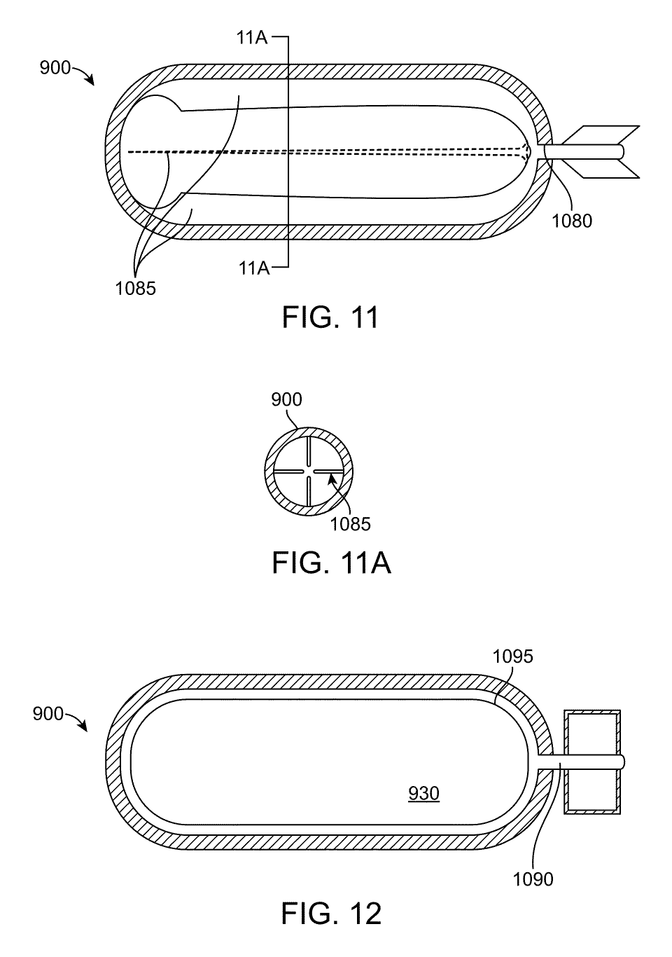

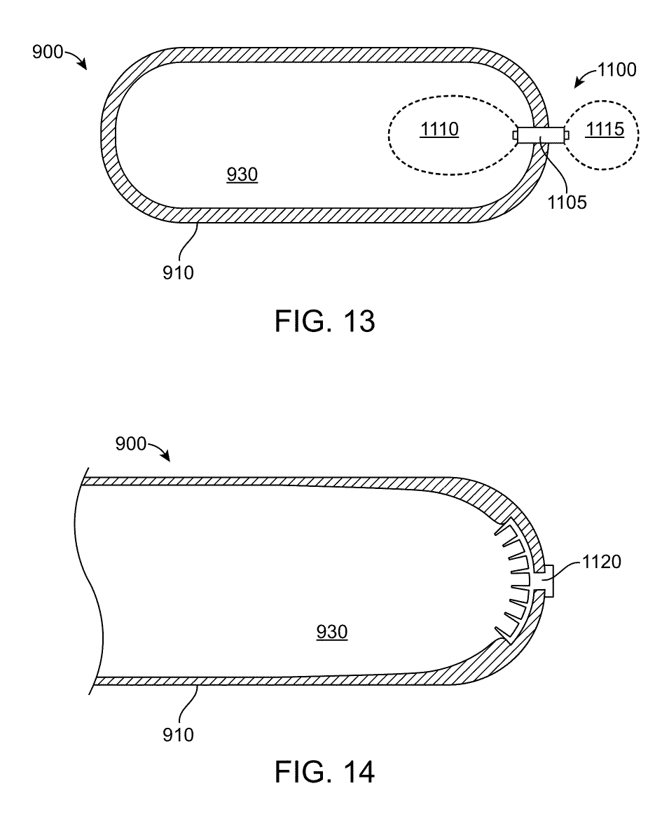

As discussed herein, the heat sink of the fuel tank 900 may have many configurations. FIG. 11 shows the fuel tank 900 as having a heat sink 1080 which may comprise a plurality of radial fins 1085 which may extend the length of the interior wall of the fuel tank 900. The radial fins may, for example, extend 10, 20, 30, 40, 50, 60, 70, 80, 90, 100, or any suitable percentage through the length of the fuel tank 900. FIG. 11A shows a cross-section of the fuel tank 900 having the heat sink 1080 taken through line 11A in FIG. 11. FIG. 12 shows the fuel tank 900 as having a heat sink 1090 which may comprise an internal portion to allow heat to transfer from the fuel tank interior 930 to the external environment. The internal portion may comprise an internal liner 1095 which may cover substantially the entire interior wall of the fuel tank 900. FIG. 13 shows the fuel tank 900 as having a variable configuration heat sink 1100. The variable configuration heat sink 1100 may comprise a fuel tank wall portion 1105 which may traverse the fuel tank wall 910. The fuel tank wall portion 1105 may be made of a highly heat conductive material and may be removably coupled to a user-selectable internal fin attachment 1110 within the fuel tank interior 930 and a user-selectable external fin attachment 1115 external of the fuel tank wall 910. A plurality of user selectable internal fin attachments 1110 and a plurality of user selectable external fin attachments 1115 may be provided. The individual fin attachments may have a variety of shapes, sizes, materials, configurations, etc. and may be swapped for one another to select a desired surface area ratio between the internal fin attachment 1110 and the external fin attachment 1115, for example. FIG. 14 shows the fuel tank 900 as having a heat conductive plate 1120 to increase the heat conductive surface area of the fuel tank wall 910. FIG. 14 shows the heat conductive plate 1120 disposed on one end of the fuel tank 900. The fuel tank 900 may comprise a second heat conductive plate 1120 disposed on the opposite end.

Generally, the heat sinks or heat conductive structures of the fuel tank 900 as described above (FIGS. 9A to 14) may passively increase the rate of heat conduction out of the fuel tank interior 910. According to aspects of the present disclosure, heat rejection may be further enhanced actively. As shown in FIG. 9A, for example, a fan 960 may optionally be provided to facilitate the cooling of the external fin(s) 946 of the heat sink 940 in the fuel tank 900. In many embodiments, a circulation system may be provided to circulate compressed gas from the fuel tank through a heat exchanger and back into the fuel tank. This circulation may be in the form of a closed loop or an open loop. The heat exchanger may use ambient air or some other cold sink to remove heat from the gas/fuel mass. Active convection at the heat exchanger may involve the use of a fan or fluid pumping mechanism to force the cold side source over the external fins of heat exchange mechanism. Additionally, the use of a circulation pump, compressor, or blower may be optional as some embodiments may use the kinetic energy of the gas and/or existing flow velocity to circulate the fluid through the heat exchange loop. This circulation can be influenced by a venturi, a fluid driven pump, compressor, or blower, or the existing flow of the gas. The various elements to actively promote heat conduction may include a highly conductive heat exchanger material (e.g., aluminum, copper, copper-tungsten alloy, AlSiC (silicon carbide in aluminum matrix), Dymalloy (diamond in copper-silver alloy matrix), E-Material (beryllium oxide in beryllium matrix), or combinations thereof) with a large surface area, a blower to circulate the gas, a fan or blower for forced convection with the cold sink, piping that can handle the high pressures involved, etc. One or more of the various elements to actively promote heat conduction may be integrated with the fuel tank during the fabrication process.

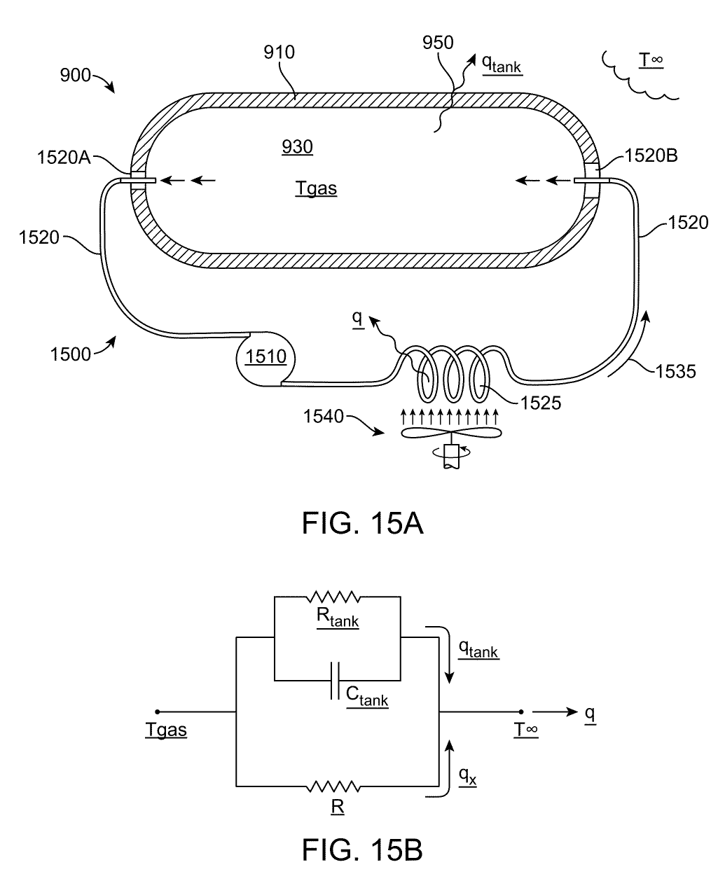

FIG. 15A shows the fuel tank 900 comprising an active gas circulation and cooling system 1500. The cooling system 1500 may comprise a pump 1510 and tubing or piping 1520 through which the compressed gas of the fuel tank interior 930 may be circulated. The piping 1520 may have an inlet end 1520A through which the compressed gas of the fuel tank 930 enters, a coiled section 1525 to promote cooling, and an outlet end 1520B through which the cooled compressed gas is reintroduced into the fuel tank interior 930. The pump 1510 may circulate the gas within the piping 1520 in the direction indicated by arrow 1535. The coiled portion 1525 may increase the surface area of the piping 1520 through which heat from the gas in the fuel tank interior 930, which is at a temperature T_{gas}, can dissipate from the piping with a flux qₓ to the ambient air of the external environment at a temperature T_{∞}. Heat may also dissipate from fuel tank interior 930 through the fuel tank wall 910 with a flux qₜₐₙₖ. An active cooling element or fan 1540 may direct or circulate ambient air or other cooling fluid over the coiled portion 1525 to promote the cooling of the gas circulating within the tubing or piping 1520.

FIG. 15B shows a heat transfer circuit diagram of the fuel tank 900 having the parallel heat flow paths as in FIG. 15A, where the heat form the gas in the fuel tank interior 930 having a temperature T_{gas} transfers to the external environment having heat or gas at a temperature T∞ with a total flux q. The total flux q may comprise the sum of the flux qₜₐₙₖ of the heat flow directly through the fuel tank wall 910 and the flux qₓ of the heat flow through the piping 1520. The fuel tank wall 910 may have a heat resistance Rₜₐₙₖ and a heat capacitance Cₜₐₙₖ. The piping 1520 may have a heat resistance of R_{coil}. If Rₜₐₙₖ is greater than R_{coil}, then qₓ may be greater than qₜₐₙₖ in stable conditions.

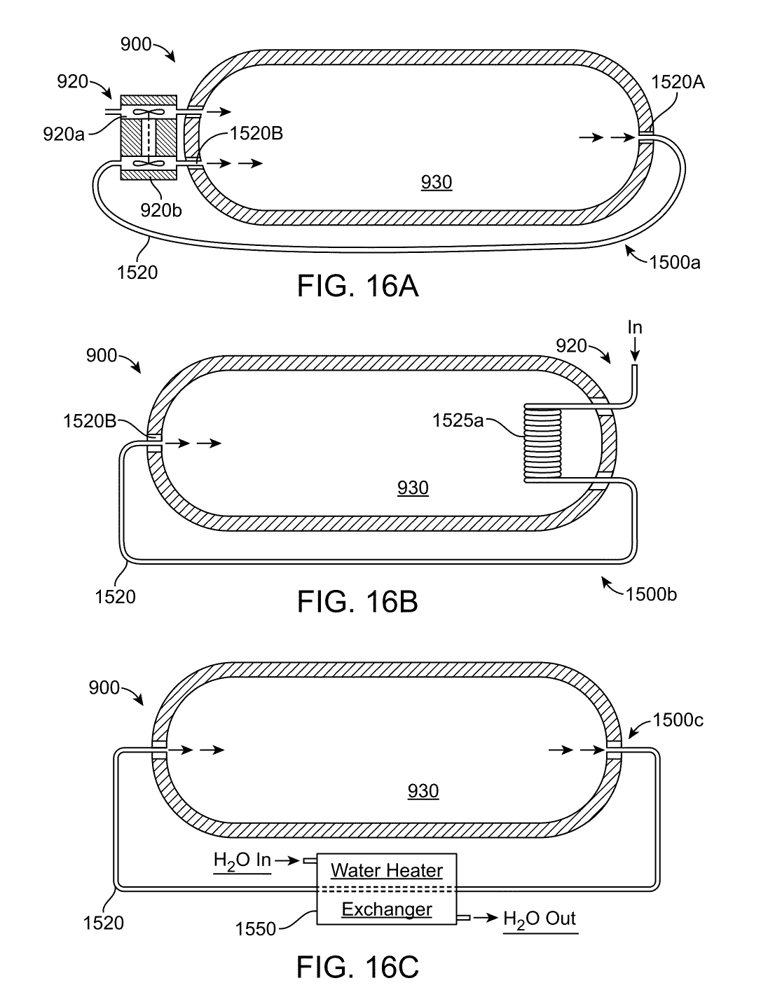

The cooling system may have various configurations and may be active and/or passive. As shown in FIG. 16A, an active cooling system 1500a may be integral with the inlet 920. The compressed gas may be introduced into the fuel tank interior 930 may exit through the piping inlet end 1520A, may pass through the portion of the piping 1520 in the external environment or ambient air, and may be reintroduced through the piping outlet end 1520B or the fuel inlet 920. The gas may cool as it circulates through the piping 1520. The cooling system 1500a may itself be powered by the introduction or filling of gas into the fuel tank 900. The fuel inlet 920 may comprise a turbine 920a which is actuated when the gas tank 900 is filled with compressed gas. The actuation of the turbine 920a actuates a turbine 920b which circulates the gas through the piping 1520.

As shown in FIG. 16B, a cooling system 1500b may be integral with the inlet 920. The gas of the fuel tank interior 910 may be cooled as the fuel tank 900 is filled. The cooling system 1500b may comprise a piping 1520 having an interior coiled portion 1525a disposed within the fuel tank interior 920. Compressed gas may be introduced into the inlet 920, may absorb heat from the fuel tank interior 1520 through the coiled portion 1525, may pass into the exterior portion of the piping 1520 which may be cooled by the external environment or ambient air, and may then be introduced into the fuel tank interior 930.

As shown in FIG. 16C, a cooling system 1500c may comprise a water or liquid based heat exchanger 1550 coupled to the piping 1520 to cool the gas circulating therein.

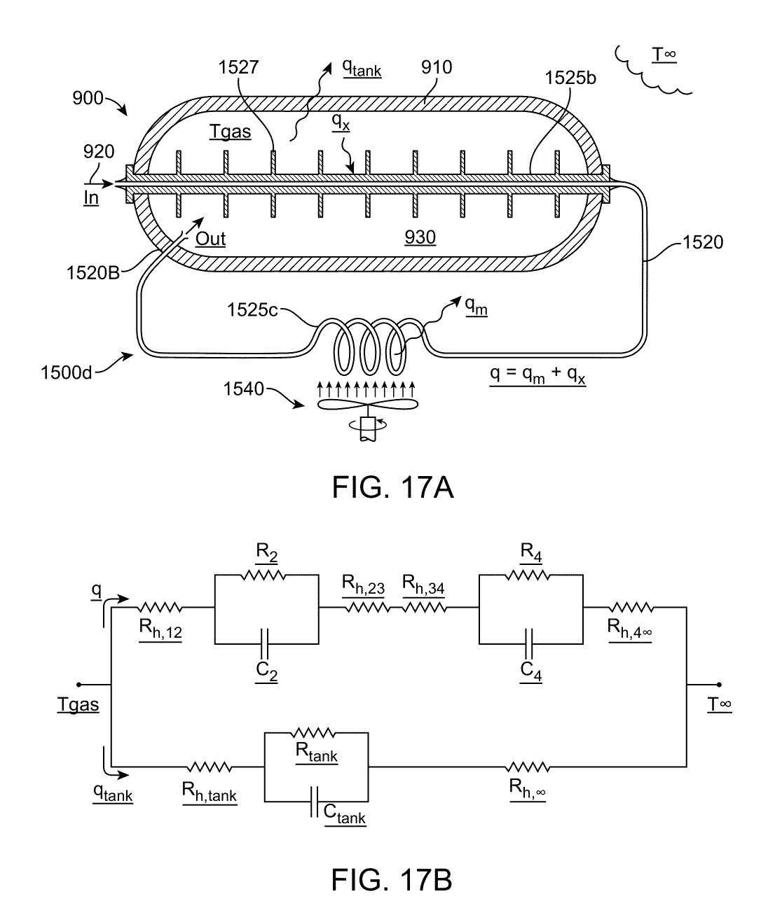

FIG. 17A shows the fuel tank 900 as having a fuel cooling system 1500d. The fuel cooling system 1500d may be integral with the fuel inlet 920. Before the gas or fuel is introduced into the fuel tank interior 930, the gas or fuel may pass through the fuel tank interior 930 within the piping 1520 to collect heat therein and may pass through the piping 1520 including the coiled portion 1525c before being introduced into the fuel tank interior 930 through piping outlet end 1520B. The portion 1525b of the piping 1520 disposed in the fuel tank interior 930 may comprise a plurality of fins or a finned exterior 1527 made of a highly heat conductive material to increase the surface area of the piping portion 1525b and facilitate the transfer of heat between the piping portion 1525b and the fuel tank interior 930. The external coiled portion of the piping 1525c may be cooled by a fan 1540. The total heat flux q provided by the fuel cooling system 1500d may comprise the sum of the heat flux qₓ through the internal piping portion 1525b and the heat flux q_{∞} through the piping 1520 including the fanned coiled portion 1525c.

FIG. 17B shows a heat transfer circuit diagram of the fuel tank 900 having the parallel heat flow paths as in FIG. 17A, where the heat form the gas in the fuel tank interior 930 having a temperature T_{gas} transfers to the external environment having heat or gas at a temperature T_{∞}. The total heat flux through the fuel tank 900 is the sum of the heat flux q through the fuel cooling system 1500d and the heat flux qₜₐₙₖ through the fuel tank wall 910. The fuel tank wall 910 has a heat resistance Rₜₐₙₖ and a heat capacitance Cₜₐₙₖ as well as resistances R_{h,tank} and R_{h,∞}. The piping 1520 has a plurality of heat resistances R_{h,12}, R₂, R_{h,23}, R_{h,34}, R₄, R_{h,4∞}, and R∞ at different portions of the piping 1520 and may have a heat capacitance C₂ at the finned portion 1527 and a capacitance C₄ of the walls of the piping 1520. These resistances and capacitances may be configured to be parallel, in series, or in combinations thereof.

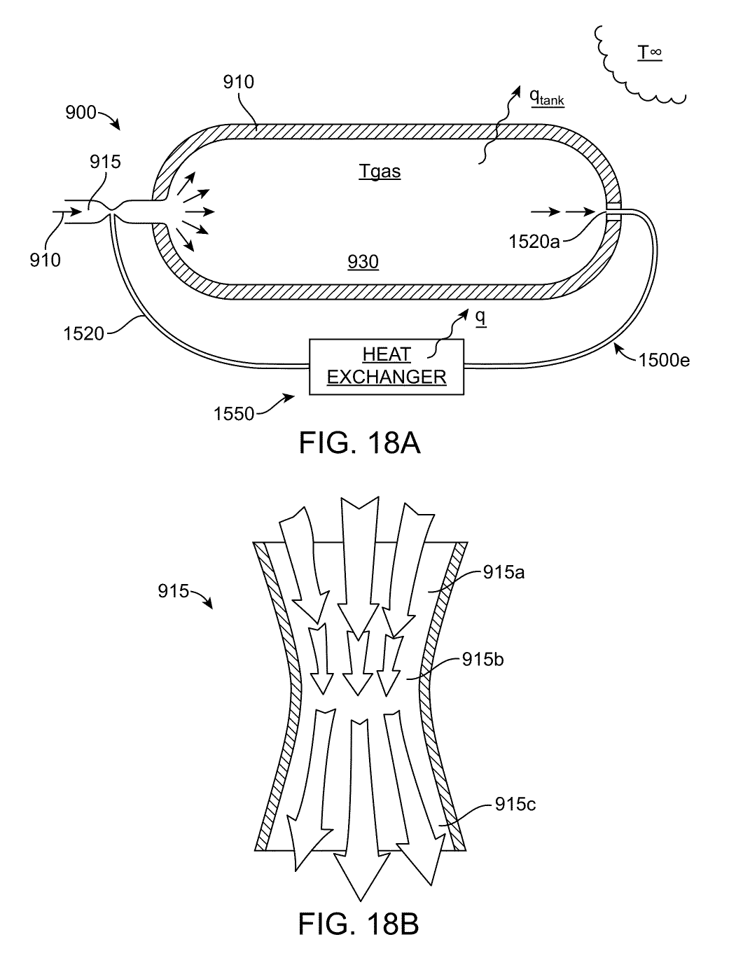

FIG. 18A shows the fuel tank 900 as having a fuel cooling system 1500e, which may be similar to the fuel cooling system 1500c shown in FIG. 16C. The fuel cooling system 1500e may further comprise a venturi tube 915 integral with the gas or fuel inlet 910. The venturi tube 915 may cool the gas or fuel as it enters the fuel tank interior 930. The venturi tube 915 may cool the entering gas or fuel with the venturi effect as known in the art. As shown in FIG. 18B, the venturi tube 915 may comprise a high pressure low velocity inlet portion 915a, a high velocity low pressure middle portion 915b, and a high pressure low velocity outlet portion 915c.

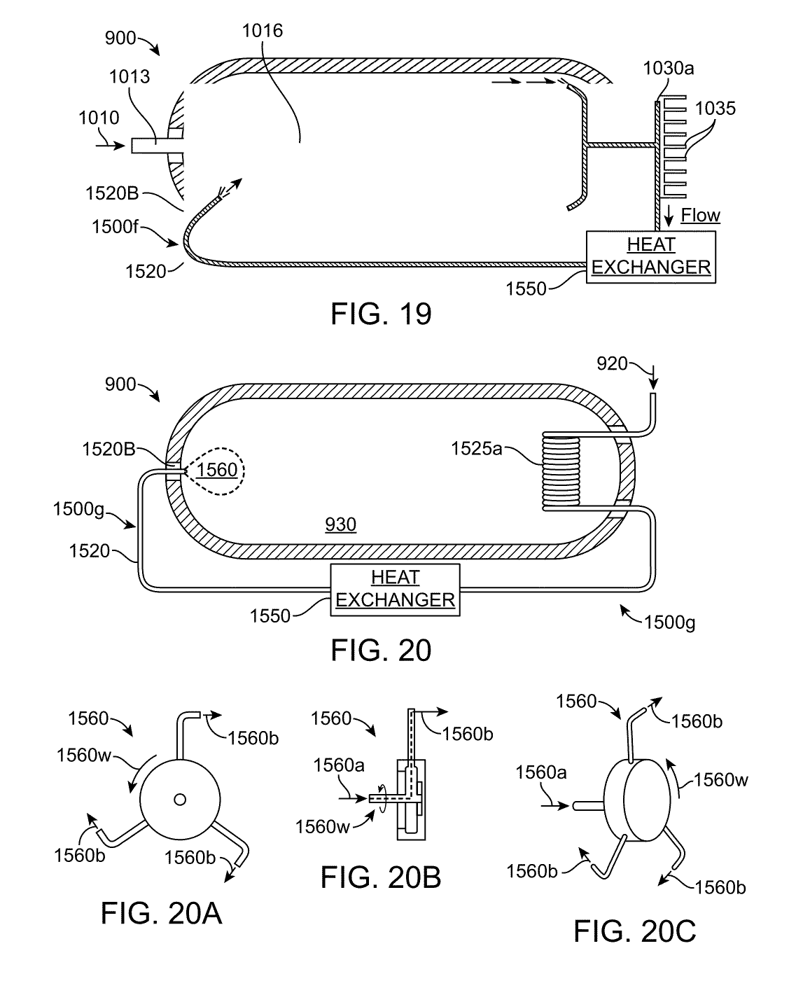

FIG. 19 shows the fuel tank 900 as having a flow modification structure 1010, a heat sink 1030a, and an active cooling system 1500f. These elements may combine to facilitate the cooling of gas introduced into the fuel tank interior. The flow modification structure 1010 may comprise a perforated tube 1013 which may introduce fuel or gas into the fuel tank interior 930 in a distributed and even manner through the plurality of openings 1016, which may provide further enhanced heat rejection than if gas or fuel were only introduced at one end of the fuel tank 900. For instance, the heat of compression may be at least 5%, 10%, 15%, 20%, 25%, 30%, 35%, 40%, 45%, 50%, 55%, 60%, 65%, 70%, 75%, 80%, 85%, 90%, or 95% less. The heat sink 1030a may comprise interior and exterior fins which facilitate cooling of the gas or fuel within fuel tank interior 910. The heat sink 1030a may comprise openings through which the tubing or piping 1520 can take in the gas from the fuel tank interior. Through the tubing or piping 1520, the fuel or gas can be circulated through a heat exchanger 1550 before being reintroduced into the fuel tank interior 910 through piping outlet 1520B.

FIG. 20 shows the fuel tank 900 as having a fuel cooling system 1500g which may be similar to fuel cooling system 1500b described above. The fuel cooling system 1500g further comprises a heat exchanger 1550 and has a swirling attachment 1560 coupled to the piping outlet end 1520B. The swirling attachment 1560 is shown in FIGS. 20A (front view), 20B (side cross-section), and 20C (perspective view). The swirling attachment may comprise an inlet end 1560a and a plurality of outlet ends 1560b through which gas or fuel enters and exits, respectively. The plurality of outlet ends may be configured such that the outflow of gas or fuel through the plurality of outlet ends 1560b causes the swirling attachment 1560 to rotate in a direction indicated by arrow 1560w. As discussed herein, introducing gas or fuel in a swirling or helical manner into the fuel tank interior 910 can enhance heat rejection.

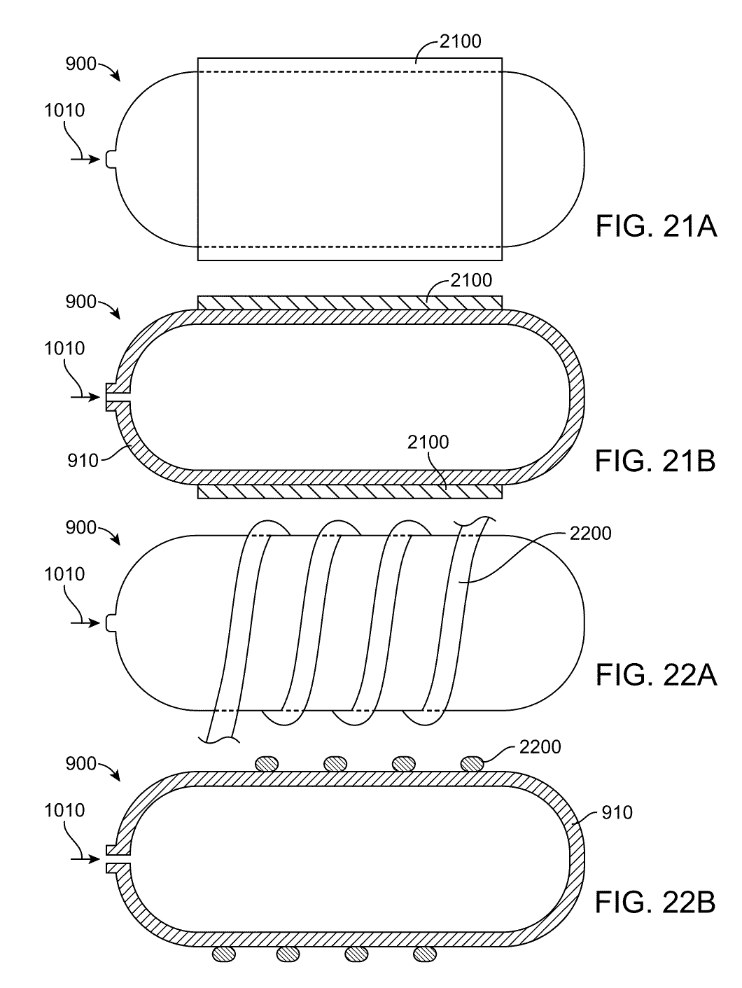

FIGS. 21A and 21B show the fuel tank 900 as having a cooling blanket 2100 wrapped around the body of the fuel tank 900. The cooling blanket 2100 may comprise a high heat conductivity material (such as those described herein) that contacts the outer surface of the fuel tank wall 910 to facilitate the transfer of heat away from the fuel tank 900 and its interior. For instance, heat from the fuel may first transfer to the wall of the fuel tank 900 through a combination of convection, conduction, and radiation, heat flux from the wall to the cooling blanket 2100 may then occur, and heat may transfer from the cooling blanket 2100 through a combination of convection and radiation. The cooling blanket 2100 may be used alone or in combination with any other fuel cooling mechanism or means described herein.

FIGS. 22A and 22B show the fuel tank 900 has having a cooling coil 2200 wrapped around the body of the fuel tank. The cooling coil 2200 may be in contact with the outer surface of the fuel tank wall 910 to facilitate the conduction of heat away from the fuel tank 900 and its interior. Coolant may be circulated through the cooling coil 2200 to facilitate cooling. The cooling coil 2200 may be used alone or in combination with any other fuel cooling mechanism or means described herein.

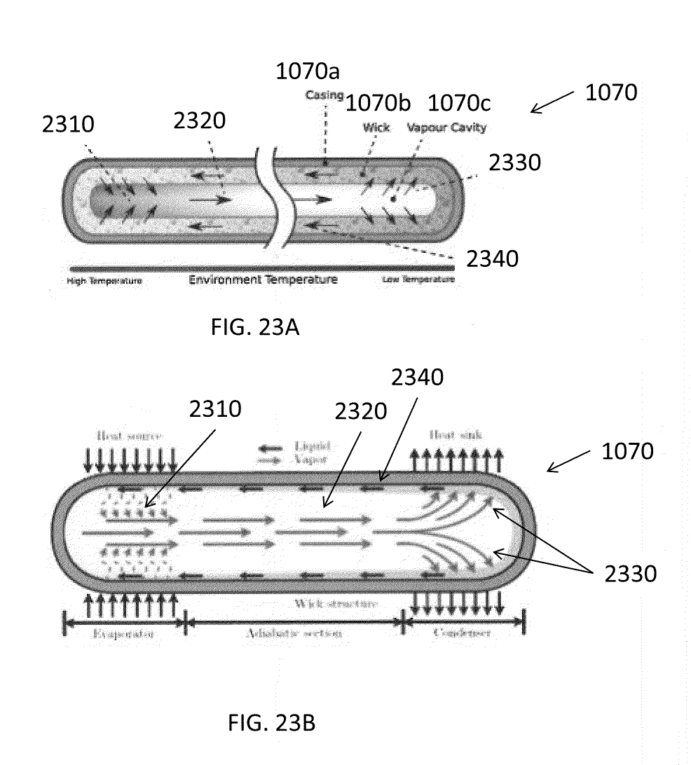

FIGS. 23A and 23B show schematics of a heat pipe thermal cycle which may be used to facilitate the cooling of compressed gas in fuel tanks according to many embodiments. FIGS. 23A and 23B shows the mechanism of cooling of the heat pipe 1070, which may comprise a casing 1070a, a wick 1070b, and a vapor cavity 1070c. Working fluid within the heat pipe 1070 may cycle between gaseous and liquid states to convey heat from one end of the heat pipe 1070 to the other. Such cycling may generate a temperature gradient between one end of the heat pipe 1070 to the other. In a step 2310, the working fluid in the high temperature portion of the heat pipe 1070 may evaporate to vapor, absorbing thermal energy. In a step 2320, the vapor may migrate along the vapor cavity 1070c to the lower temperature portion of the heat pipe 1070. In a step 2330, the vapor may condense back to fluid and may be absorbed by the wick 1070b. In a step 2340, the working fluid may flow back to the high temperature end of the heat pipe 1070.

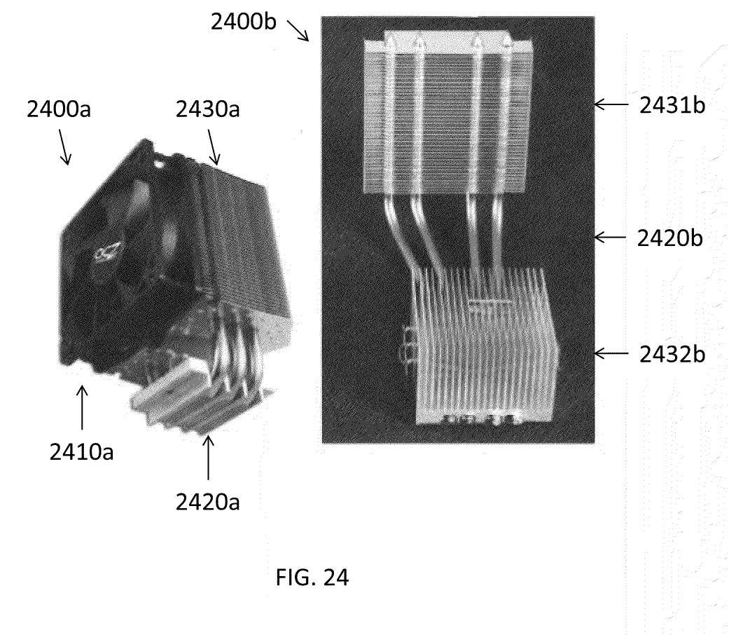

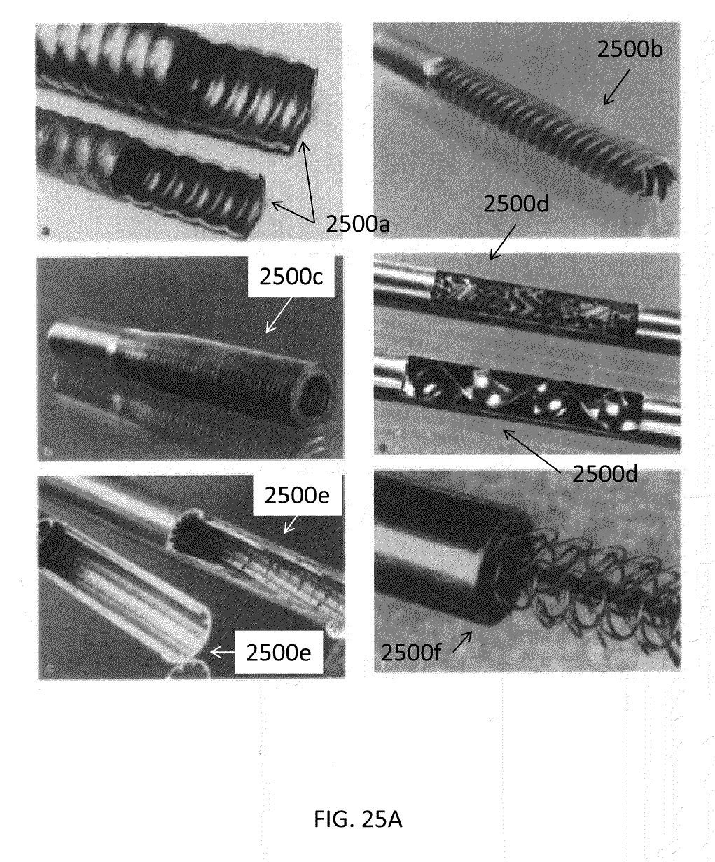

FIG. 24 shows various heat sinks 2400a and 2400b which may be used to facilitate the cooling of compressed gas in fuel tanks according to many embodiments. The heat sinks shown may be used for the internal or external fin attachment 1110 or 1115, for example. The heat sink 2400a may comprise a cooling fan 2410a and heat conduction coils 2420a which may contact higher temperature portions of a fuel tank and a high surface area grid 2430a of the heat sink 2400a to conduct the heat away from the higher temperature portions. The heat sink 2400b may comprise a first high surface area grid 2431b and a second high surface area grid 2432b coupled to one another with heat conduction coils 2420b. One or more of the first or second high surface area grids 2431a or 2432b may be configured to be in contact with higher temperature portions of a fuel tank.

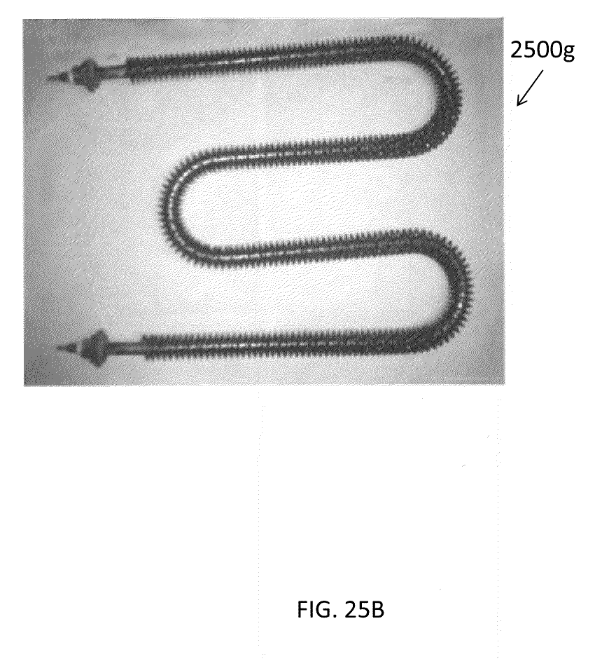

FIGS. 25A and 25B show various examples of high pressure tubing 2500a, 2500b, 2500c, 2500d, 2500e, 2500f, and 2500g which may be used for gas cooling systems to facilitate the cooling of compressed gas in fuel tanks according to many embodiments. The piping of the cooling systems described above may be similar to the tubing shown. The high pressure tubing 2500a, 2500b, 2500c, 2500d, 2500e, 2500f, and 2500g may comprise external or internal helical threads or surface indentations or protrusions. Such features may allow the high pressure tubing 2500a, 2500b, 2500c, 2500d, 2500e, 2500f, and 2500g to withstand greater pressures and/or may provide increased surface area to conduct heat.

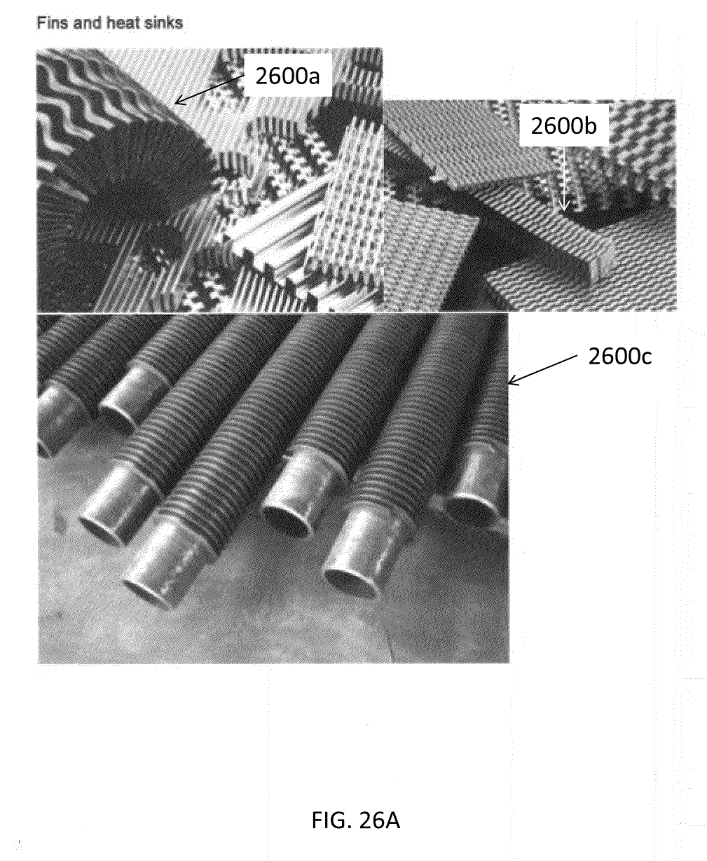

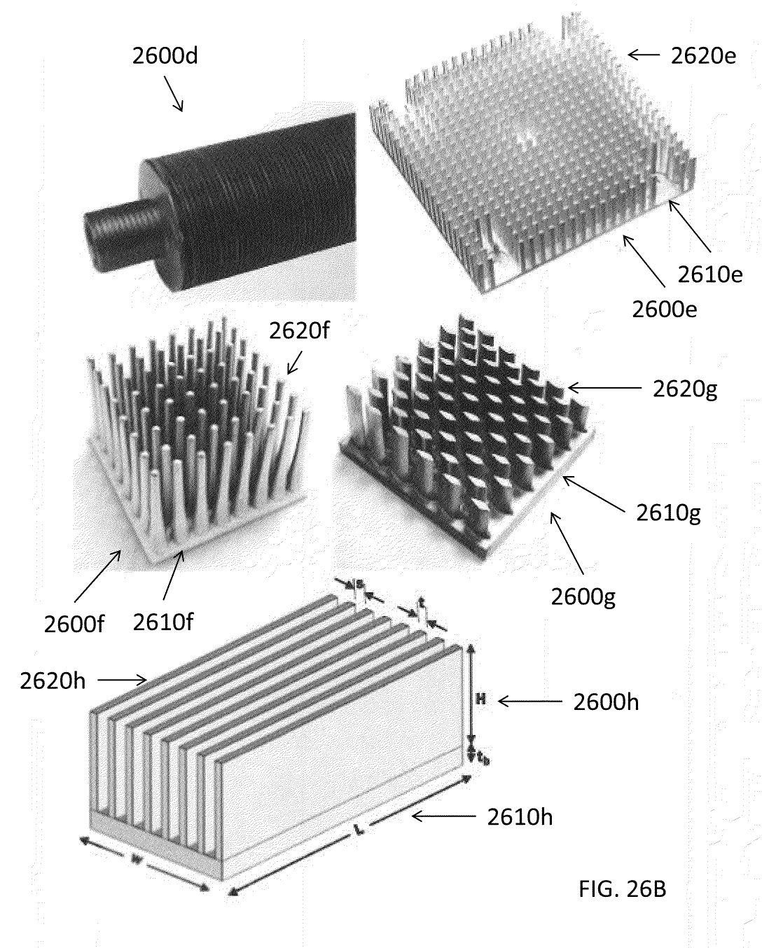

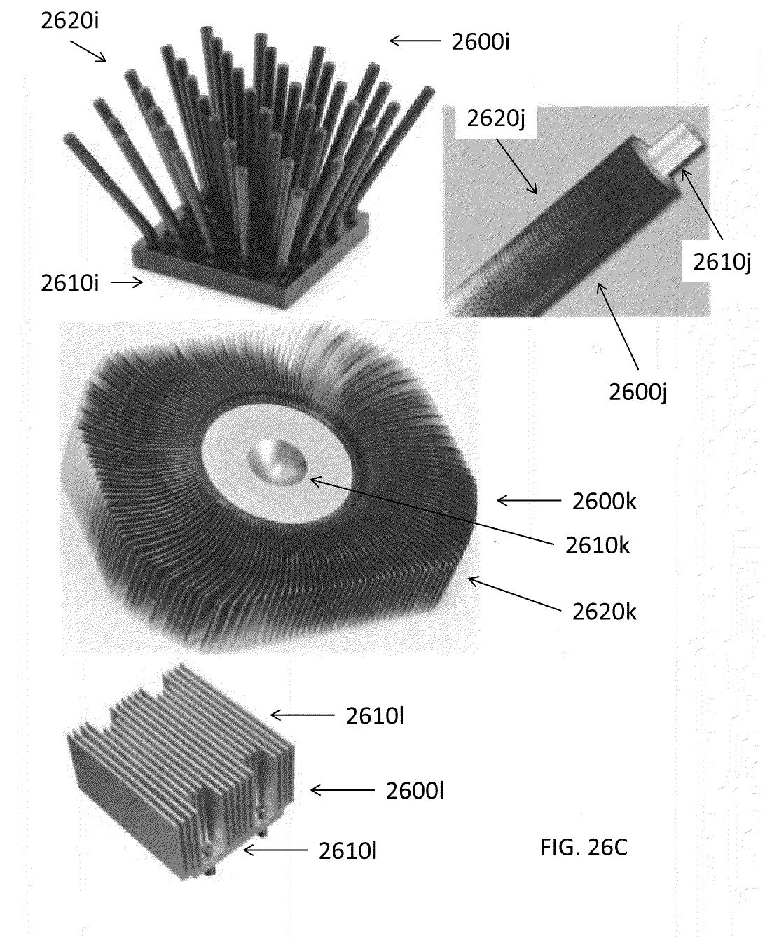

FIGS. 26A, 26B, and 26C show various examples of heat sinks 2600a, 2600b, 2600c, 2600d, 2600e, 2600f, 2600g, 2600h, 2600i, 2600j, 2600k, and 2600l which may be used to facilitate the cooling of compressed gas in fuel tanks according to many embodiments. The heat sinks shown may be used for the internal or external fin attachment 1110 or 1115, for example. The heat sink 2600a may comprise a corrugated cylinder or half-cylinder. The heat sink 2600b may comprise a corrugated and elongate rectangular member. The heat sink 2600c may comprise helically threaded tubing. The heat sink 2600d may comprise a helically threaded cylindrical member. The heat sink 2600e may comprise a flat plate 2610e with a plurality of fingers 2620e extending transverse or perpendicularly to the flat plates 2610e. The fingers 2620e may have a rectangular or square cross-section. The heat sink 2600f may comprise a flat plate 2610f with a plurality of fingers 2620f extending transverse or perpendicularly to the flat plate 2610f. The fingers 2620f may have a circular cross-section. The heat sink 2600g may comprise a flat plate 2610g with a plurality of fingers 2620g extending transverse or perpendicularly to the flat plate 2610g. The fingers 2620g may have an oval or diamond-shaped cross-section. The heat sink 2600h may comprise a flat plate 2610h and a plurality of flat plates 2620h extending transverse to the flat plate 2610h. The heat sink 2600i may comprise a flat plate 2610i with a plurality of fingers 2620i extending transverse to the flat plate 2610i and away from one another. The fingers 2620i may have a circular cross-section. The flat plates 2610e, 2610f, 2610g, 2610h, 2610i, and 2610l may contact a higher temperature portion of a fuel tank and the plurality of fingers or plates 2620e, 2620f, 2620g, 2620h, 2620i, and 2610l, respectively, may conduct heat away from the fuel tank. The plurality of fingers or plates 2620e, 2620f, 2620g, 2620h, and 2620i may provide increased surface area to facilitate cooling. The heat sink 2600j may comprise a central tube 2610j and a plurality of circular plates 2620j coupled to the exterior of the central tube 2610j. The heat sink 2600j may comprise a central member 2610k and a plurality of fins 2620k coupled to the central member 2610k to conduct heat away from the central member 2610k.

The heat sinks and tubing shown by FIGS. 23A to 26C may be used in many ways and in many combinations to provide cooling systems for the fuel tanks described herein to provide either active or passive cooling or combinations thereof.

Aspects of the present disclosure also provide further fuel tanks and further methods of filling the fuel tank with fuel, such as compressed natural gas (CNG), hydrogen, gasoline, kerosene, methane, propane, or other liquid or gaseous fuels. A fuel tank comprising a fuel storage chamber having a wall defining an interior volume and a fuel inlet positioned at least partially within the interior volume may be provided. The walled fuel storage chamber may be of any of the fuel tanks described above and herein. Fuel may be introduced into the interior volume through the fuel inlet. The fuel may be directed through a plurality of outlet perforations of the fuel insert into the interior volume. The plurality of outlet perforations may significantly reduce noise generated by the introduction of the fuel into the interior volume. For instance, the noise generated by the filling of the fuel tank 100 may be reduced by at least 5%, 10%, 15%, 20%, 25%, 30%, 35%, 40%, 45%, 50%, 55%, 60%, 65%, 70%, 75%, 80%, 85%, 90%, or 95% with the plurality of side outlets or perforations compared to without. The fuel inlet may also enhance heat rejection or transfer away from the fuel as described above and herein. The temperature increase of the fuel tank due to the heat generated may be at least 5%, 10%, 15%, 20%, 25%, 30%, 35%, 40%, 45%, 50%, 55%, 60%, 65%, 70%, 75%, 80%, 85%, 90%, or 95% less. The fuel inlet may comprise an inlet member configured to be positioned within the interior volume of the fuel tank, for example, an elongate tube or helical tube. The plurality of outlet perforations may be distributed around the inlet member. For example, the plurality of outlet perforations may be distributed axially along its length, such as along the length of the tube, and/or circumferentially about a longitudinal or central axis of the member, such as about the central or longitudinal axis of the elongate tube. The outlet perforations may be distributed in one or more rows, one or more arrays, or one or more staggered rows. The fuel inlet may further comprise a muffler disposed about the elongate tube to further reduce the first noise. For example, the muffler may comprise a covering such as a cylindrical tube disposed over the inlet member. The fuel inlet may be removably coupled to the wall of the fuel storage chamber or may be fixed to the wall of the fuel storage chamber. The fuel storage chamber may be, for example, configured to store and maintain pressure for compressed natural gas (CNG).

Examples of such a noise reducing fuel inlet having a plurality of outlet perforations are described above with reference to FIGS. 5C and 10A. Further examples of fuel inlets are described as follows. In general, the fuel inlets may occupy a length of the fuel tank, such as about 5%, 10%, 15%, 20%, 25%, 30%, 35%, 40%, 45%, 50%, 55%, 60%, 65%, 70%, 75%, 80%, 85%, 90%, 95%, or 100% of the length of the fuel tank. The outlet perforations may take up at least 5%, 10%, 20%, 30%, 40%, 50%, 60%, 70%, 80%, or 90% of a surface area of an inlet member. The filling speed of the fuel tank may be limited by the size and number of the outlet perforations and the length of the fuel inlet.

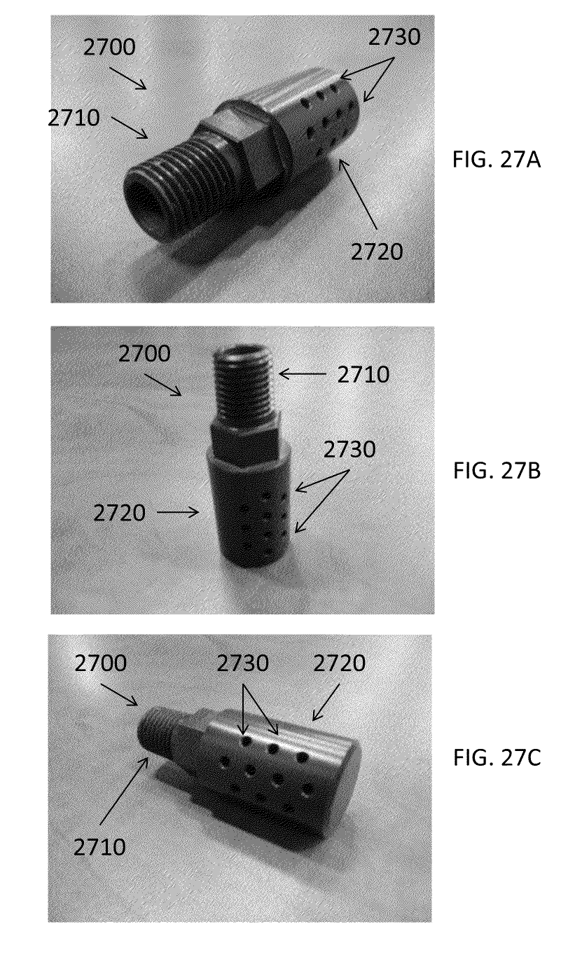

FIGS. 27A to 27C show an exemplary fuel inlet insert 2700 which may contribute to reduced noise and/or enhanced heat rejection or transfer away from the fuel upon fuel introduction or filling. The fuel inlet insert 2700 may be configured to be positioned within an interior chamber of a fuel tank. The fuel inlet insert 2700 may comprise a threaded end 2710 to couple to the wall of the fuel tank. The fuel inlet insert 2700 may further comprise an outlet end 2720 through which fuel is directed into the interior chamber of the fuel tank. The outlet end 2720 may comprise a plurality of outlet perforations 2730. The outlet perforations 2730 may be distributed over the lengths of the fuel inlet insert 2700 and over its circumference to form a plurality of columns and rows of the outlet perforations 2730. The fuel inlet insert 2700 may be manufactured with the fuel tank or may be screwed on post-manufacture.

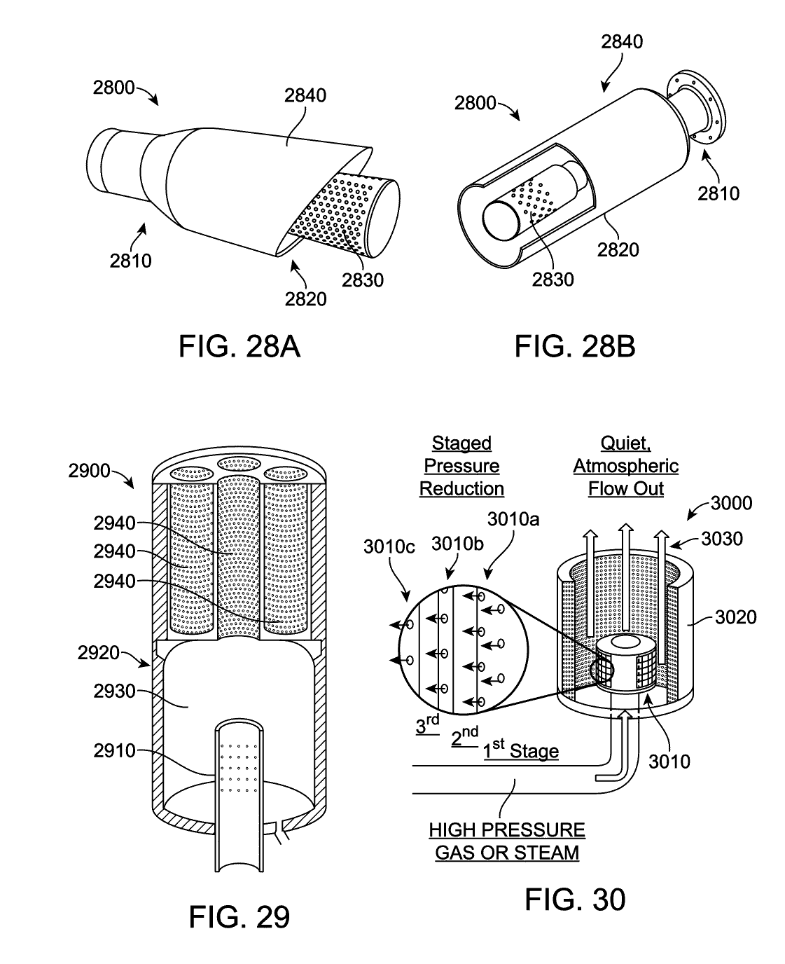

FIGS. 28A and 28B show another exemplary fuel inlet insert 2800 which may contribute to reduced noise and/or enhanced heat rejection or transfer away from the fuel upon fuel introduction or filling. The fuel inlet insert 2800 may be configured to be positioned within an interior chamber of a fuel tank. The fuel inlet insert 2800 may comprise a threaded end 2810 to couple to the wall of the fuel tank. The fuel inlet insert 2800 may further comprise an outlet end 2820 through which fuel is directed into the interior chamber of the fuel tank. The outlet end 2820 may comprise a plurality of outlet perforations 2830 which may be distributed over the length and circumference of the fuel inlet insert 2800. The outlet perforations 2830 may be distributed in a plurality of staggered, circumferential rows. The fuel inlet insert 2800 may be manufactured with the fuel tank or may be screwed on post-manufacture. The fuel inlet insert 2800 may further comprise a muffler 2840 disposed over the outlet end 2820 to further reduce noise generated by filling of the fuel tank through introduction of the fuel through the outlet end 2820. As shown in FIGS. 28A and 28B, the muffler 2840 may comprise an outer cylindrical tube.

FIG. 29 shows another exemplary fuel inlet insert 2900 which may contribute to reduced noise and/or enhancing heat rejection or transfer away from the fuel upon fuel introduction or filling. The fuel inlet insert 2900 may be configured to be positioned within an interior chamber of a fuel tank. The fuel inlet insert 2900 may comprise an inner perforated tube 2910 positioned within a first end of the fuel inlet insert 2900. The fuel inlet insert 2900 may comprise an enclosure wall 2920 disposed over the inner perforated tube 2910 and defining an interior space 2930. At the second opposite end of the fuel inlet insert 2900 and further from the interior space 2930, the fuel inlet insert 2900 may further comprise a plurality of perforated tubes 2940 which open to the interior chamber of the fuel tank. Accordingly, fuel introduced to the interior chamber of the fuel tank first passes through the perforations of the inner perforated tube 2910, the walled interior space 2930, and then the perforations of the plurality of perforated tubes 2940 before reaching the interior chamber of the fuel tank, thereby reducing noise and/or enhancing heat rejection or transfer away from the fuel.

FIG. 30 shows another exemplary fuel inlet insert 3000 which may contribute to reduced noise and/or enhanced heat rejection or transfer away from the fuel upon fuel introduction or filling. The fuel inlet insert 3000 may be configured to be positioned within an interior chamber of a fuel tank. The fuel inlet insert 3000 may comprise an inner perforated tube 3010 positioned within a first end of the fuel inlet insert 3000. The fuel inlet insert 3000 may comprise an enclosure wall 3020 disposed over the inner perforated tube 3010. At the second opposite end of the fuel inlet insert 3020, the enclosure wall 3020 may be open to allow fuel to flow through into the interior chamber of the fuel tank as indicated by arrows 3030. The inner perforated tube 3010 may comprise a plurality of perforated, concentric walls 3010a, 3010b, and 3010c. Providing a plurality of perforated, concentric walls 3010a, 3010b, and 3010c may facilitate noise reduction but may slow down the filling speed of the fuel tank as the fuel would have increased path lengths to enter the fuel tank. Fuel introduced through the inner perforated tube 3010 may pass through the outlet perforations of the combination of walls before passing out of the fuel inlet insert 3000, thereby, thereby reducing noise and/or enhancing heat rejection or transfer away from the fuel.

The many devices, device components, and methods for enhancing heat rejection and/or reducing noise associated with fuel introduction or filling described above and herein are described as examples only. The many device, device components, and methods can be combined and/or varied in many ways to enhance heat rejection and/or reduce noise associated with fuel introduction or filling without departing from the scope of the present disclosure.

While preferred embodiments of the present disclosure have been shown and described herein, it will be obvious to those skilled in the art that such embodiments are provided by way of example only. Numerous variations, changes, and substitutions will now occur to those skilled in the art without departing from the scope of the present disclosure. It should be understood that various alternatives to the embodiments of the present disclosure described herein may be employed in practicing the inventions of the present disclosure. It is intended that the following claims define the scope of the invention and that methods and structures within the scope of these claims and their equivalents be covered thereby.

What is claimed is:

1. A fuel tank comprising:
a fuel storage chamber having a fuel storage chamber wall defining an interior volume; and
a heatsink coupled to the fuel storage chamber wall, the heatsink comprising an interior heatsink portion disposed within the interior volume of the fuel storage chamber and an exterior heatsink portion exposed to an exterior of the fuel storage chamber wall to facilitate heat transfer between the interior volume and the exterior of the fuel storage chamber wall;
a fuel inlet coupled to the fuel storage chamber wall; and
a flow modification element coupled to the fuel inlet,
wherein the flow modification element and the heatsink combine to reduce heat generated by filling of the fuel tank.

2. The fuel tank of claim 1, wherein the fuel inlet is disposed on a first side of the fuel storage chamber wall and the heatsink is disposed on a second side of the fuel storage chamber wall.

3. The fuel tank of claim 1, wherein the flow modification is disposed at least partially within the interior volume of the fuel storage chamber when coupled to the fuel inlet.

4. The fuel tank of claim 3, wherein the flow modification element is configured to outlet the fluid into a middle portion of the interior volume of the fuel storage chamber when the fuel storage chamber is filled with the fuel.

5. The fuel tank of claim 1, wherein the flow modification element is removably attached to the fuel inlet.

6. The fuel tank of claim 5, wherein the flow modification element is configured to direct the fuel to flow in a vortex manner within the interior volume of the fuel storage chamber.

7. The fuel tank of claim 1, wherein the interior heat sink portion is integral with the exterior heat sink portion.

8. The fuel tank of claim 1, wherein the heatsink further comprises a heatsink wall portion coupling the interior heatsink portion with the exterior heatsink portion, the heatsink wall portion being coupled to the fuel storage chamber wall.

9. The fuel tank of claim 1, wherein the interior heatsink portion comprises at least one interior fin.

10. The fuel tank of claim 1, wherein the exterior heatsink portion comprises at least one exterior fin.

11. The fuel tank of claim 1, wherein the fuel storage chamber is configured to store and maintain pressure for compressed natural gas (CNG).

12. A system for storing fuel, the system comprising:
the fuel tank of claim 1; and
an active cooling element for cooling the exterior heatsink portion, wherein the active cooling element comprises at least one of a fluid bath, a fan, or a coolant system.

13. A method of filling a fuel tank with fuel, the method comprising:
providing a fuel tank comprising a fuel inlet, a fuel storage chamber having a wall defining an interior volume, and a heatsink coupled to the wall, the heatsink being disposed within the interior volume and exposed to an exterior of the wall;
introducing fuel into the interior volume through the fuel inlet, wherein introducing the fuel generates a heat of compression; and
directing, with the heatsink, at least a portion of the generated heat of compression from the interior volume to the exterior of the wall of the fuel storage chamber, wherein introducing fuel into the interior volume comprises channeling the fuel through a flow modification element,
wherein the heatsink and the flow modification element combine to reduce heat generated by filling of the fuel tank.

14. The method of claim 13, wherein channeling the fuel through the flow modification element causes the fuel to flow into the interior volume in a vortex manner.

15. The method of claim 13, wherein channeling the fuel through the flow modification element comprises introducing the fuel into a middle portion of the interior volume.

16. The method of claim 13, further comprising coupling the flow modification element to the fuel inlet.

17. A method of filling a fuel tank with fuel, the method comprising:
providing a fuel tank comprising a fuel storage chamber having a wall defining an interior volume and a fuel inlet positioned at least partially within the interior volume; and
introducing fuel into the interior volume through the fuel inlet,
wherein the fuel is directed through a plurality of outlet perforations of the fuel insert into the interior volume, the plurality of outlet perforations reducing noise generated by the introduction of the fuel into the interior volume, and
wherein introducing fuel through the fuel inlet modifies the flow of the fuel to reduce heat generated by filling of the fuel tank.

18. The method of claim 17, wherein the fuel inlet comprises an elongate tube positioned within the interior volume of the fuel tank.

19. The method of claim 18, wherein the plurality of perforations is distributed at least one of axially along a length of the elongate tube or circumferentially about a longitudinal axis of the elongate tube.

20. The method of claim 18, wherein the fuel storage chamber is configured to store and maintain pressure for compressed natural gas (CNG).
